(19) United States
(12) Patent Application Publication
(10) Pub. No.: US 2006/0108017 A1
(43) Pub. Date: May 25, 2006

(54) Multiple pipe, method of manufacturing the multiple pipe and device for manufacturing multiple pipe

(76) Inventors: Tomoyuki Nakajima, Shizuoka-ken (JP); Tamio Yoshino, Shizuoka-ken (JP); Yoji Tashiro, Shizuoka-ken (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/287,156

(22) Filed: Nov. 23, 2005

Related U.S. Application Data
(63) Continuation of application No. PCT/JP04/07079, filed on May 24, 2004.

(30) Foreign Application Priority Data
May 23, 2003 (JP) 2003-146001

(51) Int. Cl. F16L 9/14

(52) U.S. Cl. 138/149; 138/148; 138/114

(57) ABSTRACT

The multiple pipe component is a pipe made up of at least an inner pipe and an outer pipe in which a fibrous filler is positioned between the outer pipe and the at least one inner pipe in a region that will be bent. The filler is formed with slits spaced at given pitches. Holes are provided in the inner pipe on at least one of the downstream side and the upstream side of the inner pipe in the bending region while holes are not disposed in the bending region.

### CROSS-REFERENCE TO RELATED APPLICATIONS

This application is a continuation of International Patent Application No. PCT/JP04/07079, filed on May 24, 2004, which is based upon Japanese Patent Application No. 2003-146001, which was filed on May 23, 2003, each of which is hereby incorporated by reference in its entirety.

### BACKGROUND OF THE INVENTION

1. Field of the Invention

The present invention generally relates to a multiple pipe component, such as an a double wall exhaust conduit that serves to conduct gases from the engine to the muffler or catalyst of a motorcycle, a snow mobile, a four-wheeled buggy or all terrain vehicle, or the like. The present invention also generally relates to bending a pipe that can be used in transporting liquids of solid bodies, such as powder and further substances each, composed in combination of any two or all of a gas, a liquid and a solid body. The present invention also relates to a method of manufacturing the multiple pipe component and a device for manufacturing the multiple pipe component.

2. Description of the Related Art

In some types of exhaust components for motorcycles, the pipe is formed by an inner pipe and an outer pipe. A generally heat resistant, sound absorbing material is fitted between the inner and outer pipes. Thus, the pipe is configured such that each of the inner pipe and the outer pipe is formed of two semicircular pieces with the heat resistant sound absorbing material held between the pieces. The pieces then are brought into abutment against each other and flange portions at both sides are joined together. Such a construction is shown, for instance, in Japanese Publication No. Hei 8-121157 in FIG. 4 and described at page 1 of that publication.

In other configurations of bent exhaust pipes for motorcycles, each of the outer pipe and the inner pipe is formed of two pipes in the region of the bend. With respect to the outer pipes, a pair of semicircular porous wall members abuts a first outer pipe that has been bent with a pipe bender. A heat resistant, sound absorbing material covers the outside circumference of a second inner pipe, which is bent to correspond to the bent portion of the first outer pipe. The bend of the second inner pipe is inserted into the bent portion of the first outer pipe. A heat resistant, sound absorbing material covers the outside circumference of a first inner pipe, which is generally straight and formed by a pair of semicircular, porous wall members that abut each other. The first inner pipe is inserted into the straight portion of the first outer pipe. Further, a second outer straight pipe is fitted on a second inner pipe which is covered with a heat resistant, sound absorbing material. The first and the second outer pipe abut each other and are welded circumferentially. The first and second inner pipes are fitted together where they abut and the axial position of the abutting region sometimes differs from the outer pipe to the inner pipe. Such a construction is shown and described in Japanese Patent No. 2902388, at page 4 and in FIGS. 3 and 4, for instance.

In addition, a method of bending a pipe used conventionally for piping, a heat exchanger, or the like, has been disclosed in which the pipe is filled with a freezing liquid and frozen for bending. For instance, such a construction is shown and described in Japanese Publication No. Hei 5-200437, at pages 1 through 3 and in FIGS. 1 through 3.

Each of these attempts fails in its own regard to produce a suitable component. For instance, in the first described arrangement, the pipe is formed of multiple pieces that are joined at a flange. Such a construction provides a poorly constructed appearance. In addition, because the flanges protrude outward at both sides of the pipe, the flanges can cause difficulties during handling of the pipe. The handling difficulties can adversely impact the assembly process as well as the serviceability of the pipe.

Moreover, because the inner lumen is defined by the two halves of the inner pipe, which are joined together, two grooves are formed that are generally parallel to the axial center of the inner pipe. When such a pipe is used to transport a solid body, such as powder, other solid granular materials, a gas, a liquid mixed with a solid, or a fluid of a gas-liquid mixture, the solidified bodies, such as powder and the like or deteriorated liquids, are likely to collect in the two grooves.

Further, a total of four pieces (i.e., two inner pipe components and two outer pipe components) need to be formed in advance and these components must be joined at both sides, which undesirably increases the manufacturing cost.

Similarly, in the second described arrangement, a total of four pieces (i.e., two inner pipe components and two outer pipe components) need to be formed and the outer pipe is welded, which results in an increased manufacturing cost. Further, because of the need to weld the outer pipe, the external appearance of the final product is poor. The handling properties of the pipe are deteriorated due to the welded portions, which results in adversely impacts assembling properties and serviceability.

Moreover, due to the circumferential step or groove that is formed in the butt-fitted portion of the inner pipe, when the pipe is used for transporting a solid body such as a solid body, such as powder, other solid granular materials, a gas, a liquid mixed with a solid, or a fluid of a gas-liquid mixture, the solidified bodies, such as powder and the like or deteriorated liquids, are likely to collect in the groove.

With respect to the third described arrangement, when a glass wool, a catalyst or any other fibrous filler is disposed between any given pipes (e.g., between the inner and outer pipes for a double walled pipe), it is difficult to impregnate the fibrous filler with a liquid to freeze the inner part of the multiple pipe for bending. In addition, it is difficult, if not impossible, to fully replace the air in the filler with a liquid. If the liquid is then frozen with air left in the pipe at the portion where the filler is disposed, and if the pipe then is bent at the portion where the filler is disposed, the outer pipe or the inner pipe will be deformed such that the inner pipe is constricted at the bend. Such a deflect results in a reduction in the sectional area of the pipe or large irregularities in the inside wall of the inner pipe due to folds or swellings. Moreover, the outer pipe also will be formed with irregularities at the bend, which results in a poor external appearance.

### SUMMARY OF THE INVENTION

In view of the foregoing problems, an object of the present invention is to provide a multiple pipe, a method of manufacturing the multiple pipe and a device for manufacturing the multiple pipe, which produce a bent pipe having a high quality of external appearance while reducing the manufacturing cost and reducing the amount of deformation irregularities in the region of the bend where a filler is disposed.

Accordingly, one aspect of the present invention involves a multiple pipe component that comprises at least one inner pipe and an outer pipe. A fibrous filler is disposed between the at least one inner pipe and the outer pipe at a portion of the multiple pipe component pipe that will be bent.

Another aspect of the present invention involves a method of manufacturing a multiple pipe component. The multiple pipe component comprises an inner pipe that is inserted into an outer pipe and a fibrous filler that is positioned around the outer circumference of the inner pipe. The method comprises introducing an ice-bending liquid into the multiple pipe, freezing the ice-bending liquid and, while the ice-bending liquid is frozen, bending the pipe in the region in which the filler is disposed.

A further aspect of the present invention involves a method of manufacturing a multiple pipe component. The multiple pipe component comprises an outer pipe, at least one inner pipe disposed inside the outer pipe, and a fibrous filler positioned in at least one portion of a space defined between the at least one inner pipe and the outer pipe. The multiple pipe component comprises a region that will be bent. The method comprises supplying a liquid into the inner pipe at the region that will be bent and supplying a liquid to the space between the pipes including the portion where the filler is disposed. The liquid is frozen after being supplied. The pipe is bent after the liquid is frozen and, when the liquid is fed into the portion where the filler is disposed, the supply of the liquid occurs by one or more of the following two process: a process in which the liquid is supplied under pressure from at least one side of the portion where the filler is positioned and a process in which the liquid is supplied from one side of the portion where the filler is disposed while it is depressurized from the other side thereof.

An aspect of the present invention also involves a method of manufacturing a multiple pipe made up of at least one inner pipe and one outer pipe. A pipe bending portion is defined between the ends of the multiple pipe. An outer space is defined between the outer pipe and the inner pipe. An inner space is defined within the inner pipe. A fibrous filler is disposed at the pipe bending portion of the multiple pipe in the outer space. An opening between the outer space and the inner space is positioned in a region outside of the pipe bending portion. Holes are provided in the inner pipe on at least one of the downstream side and the upstream side of the pipe bending portion and no holes are disposed at the bending portion. The method comprises inclining the multiple pipe into a generally vertical orientation with the holes being positioned vertically lower than the pipe bending portion and the opening being positioned vertically higher than the filler, blocking the inner pipe with a seal at a position vertically above the holes and vertically below the opening, supplying a liquid under pressure from a location generally below the seal, removing the seal is after the liquid is fed from the holes through the portion where the filler is disposed and through the opening, introducing a specified amount of liquid into the inner pipe of the multiple pipe, freezing the liquid in the multiple pipe and bending the multiple pipe in the pipe bending portion while the liquid is frozen.

A further aspect of the present invention involves a method of manufacturing a multiple pipe component that comprises at least one inner pipe and an outer pipe. The multiple pipe component comprises a bending region that will be bent with the at least one inner pipe having an upstream portion positioned to one side of the bending region and a downstream portion positioned to the other side of the bending region. The method comprises positioning a fibrous filler between the outer pipe and the at least one inner pipe at the bending region with an opening between the at least one inner pipe and the outer pipe being located at a position vertically higher than the filler, creating holes through the inner pipe on at least one of the downstream portion and the upstream portion and not creating holes through the inner pipe in the bending region, positioning the multiple pipe component in either a vertically inclined position or a substantially upright position with the holes through the inner pipe being positioned vertically lower than the pipe bending portion, substantially sealing the inner pipe with a seal positioned at a position generally vertically higher than the holes, feeding a liquid under pressure from a lower end of the outer pipe, and removing the seal from the inner pipe after the liquid is introduced

An aspect of the present invention involves a method of manufacturing a multiple pipe comprising an outer pipe and at least one inner pipe disposed inside the outer pipe. An outer space is defined between the outer pipe and the at least one inner pipe and an inner space is defined within the inner pipe. A fibrous filler is disposed in the outer space in a bending region of the multiple pipe. The method comprises plugging the multiple pipe at the lower end, positioning the multiple pipe generally upright, supplying a liquid into the inner space at the bending portion and the outer space, including the bending portion that contains the filler, vibrating the multiple pipe to extract air bubbles, freezing the liquid and bending the multiple pipe.

Another aspect of the present invention involves a device for manufacturing a multiple pipe. The multiple pipe comprises an inner pipe extending into an outer pipe with a fibrous filler being positioned around an outside circumference of the inner pipe. The device comprises a pressurized liquid introduction machine capable of supplying an ice-bending liquid into the portion where the filler is disposed, a plugging and liquid introduction machine for plugging both ends of the multiple pipe and supplying a specified amount of ice-bending liquid into the pipe, a freezing machine for freezing the ice-bending liquid inserted into the multiple pipe, a bending machine for bending the frozen multiple pipe at the portion where the filler is disposed and a thawing machine for thawing the frozen ice-bending liquid in the multiple pipe.

An additional aspect of the present invention involves a device for manufacturing a multiple pipe. The multiple pipe comprises an outer pipe and at least one inner pipe extending inside the outer pipe with a fibrous filler being disposed in a space between the outer pipe and the at least one inner pipe. The device comprises a bending machine for bending the multiple pipe at the portion where the filler is dispose in the longitudinal direction, a liquid supply device for supplying a liquid into the at least one inner pipe at the bending portion and a space between the at least one inner pipe and the outer pipe, including the portion where the filler is disposed, a freezing device for freezing the liquid after introduction, a bending machine for bending the multiple pipe after freezing, and a thawing device for thawing the frozen liquid in the multiple pipe after bending, wherein the liquid supply device supplies the liquid under pressure from at least one side of the portion where the filler is disposed or the liquid supply device supplies the liquid from one side of the portion where the filler is disposed while a vacuum is applied to the other side.

Yet another aspect of the present invention involves a device for manufacturing a multiple pipe. The multiple pipe comprises an outer pipe and an inner pipe positioned at least partially inside of said outer pipe with a fibrous filler being disposed between the outer pipe and the inner pipe in a bending portion. Holes are provided in the inner pipe on at least one of a downstream side and an upstream side of the bending portion while the holes are not disposed in the bending portion. The multiple pipe is filled with liquid in a generally vertical orientation with the holes disposed further downward than the bending portion and an opening between the outer pipe and the inner pipe being located at a position further upward than the portion where the filler is disposed. The inner pipe is blocked with a seal at a position further upward than the holes. The device comprises a first supply machine for introducing a liquid under pressure from the lower end of the outer pipe, the first supply machine being capable of introducing the liquid from the opening into the portion where the filler is disposed. The device also comprises a second supply machine for supplying a specified amount of ice-bending liquid into the inner pipe of the multiple pipe. The device also comprises a bending machine for bending the multiple pipe at the portion where the filler is disposed with the liquid inside the multiple pipe frozen. The device further comprises a thawing device for thawing the frozen liquid inside the multiple pipe.

A further aspect of the present invention involves a device for manufacturing a multiple pipe made up of an outer pipe and at least one inner pipe disposed inside the outer pipe. The multiple pipe comprising a fibrous filler disposed at least in one place of the inner pipe or the space between pipes. The device comprises a bending machine for bending the multiple pipe at the place where the filler is disposed in the longitudinal direction, a liquid supply device for introducing, prior to bending, a liquid into the inner pipe inside the outer pipe at the bending portion and the space between pipes including the portion where the filler is disposed, a bubble extracting machine for extracting bubbles in the portion where the filler is disposed by applying a vibration to the multiple pipe having a lower end plugged tightly and inclined to the vertical direction or raised upright and a freezing device for freezing the liquid supplied to the multiple pipe after the extraction of the bubbles, wherein the bending machine bends the multiple pipe after the liquid fed into the multiple pipe is frozen.

### BRIEF DESCRIPTION OF THE DRAWINGS

These and other features, aspects and advantages of the present invention will be described with reference to the drawings. The drawings comprise 24 figures.

FIG. 1 is a view showing one embodiment of a multiple pipe component and a method for manufacturing the multiple pipe component.

FIG. 2 is a view showing another embodiment of a multiple pipe component and a method for manufacturing the multiple pipe component.

FIG. 3 are views showing a manufacturing process of multiple pipe components.

FIG. 4 is a view showing an exhaust pipe for a motorcycle;

FIG. 5 is a schematic view showing an arrangement of a manufacturing device for a multiple pipe component.

FIG. 6 is a schematic general control block diagram of the manufacturing device of FIG. 5.

FIG. 7 is a view showing an ice-bending/hydraulic system and an associated liquid circulation path.

FIG. 8 is a schematic structural view of a pressurized liquid introduction machine.

FIG. 9 is a time chart of pressurized liquid introduction of an ice-bending liquid.

FIGS. 10(a) through 10(d) are views showing an example of a introduction sequence for the ice-bending liquid.

FIGS. 11(a) through 11(d) are views showing another example of a introduction sequence for the ice-bending liquid;

FIG. 12 is a schematic structural view of a plugging and liquid introduction machine.

FIGS. 13(a) and 13(b) are views that show a plugging structure.

FIG. 14 is an operational time chart of the plugging and liquid introduction machine.

FIG. 15 is a view showing a bubble extracting machine.

FIG. 16 is a schematic structural view of a freezing tank and a freezer.

FIG. 17 is a plan view of the freezing tank.

FIG. 18 is a side view of the freezing tank.

FIG. 19 is a plan view of a bender.

FIG. 20 is a side view of the bender.

FIG. 21 is a view showing a thawing machine.

FIG. 22 is a view showing a plug opening machine.

FIG. 23 is a plan view of a dryer.

FIG. 24 is a side view of the dryer.

### DETAILED DESCRIPTION OF THE PREFERRED EMBODIMENT

With reference now to the drawings, an embodiment of a multiple pipe component, a method of manufacturing the multiple pipe component and a device for manufacturing the multiple pipe component will be described below in detail. It should be understood that the embodiment herein described is with reference to but one embodiment of the invention and the present invention is not intended to be limited to this embodiment. According to the illustrated embodiment, a multiple pipe component that is made up of at least an inner pipe and an outer pipe with a bend can be obtained in which a fibrous filler is disposed at the pipe bending portion of the multiple pipe between the outer pipe and inner pipe. Furthermore, the illustrated embodiment facilitates the creation of such a component while reducing the cost of manufacture and assembly and increasing the quality of the component's external appearance.

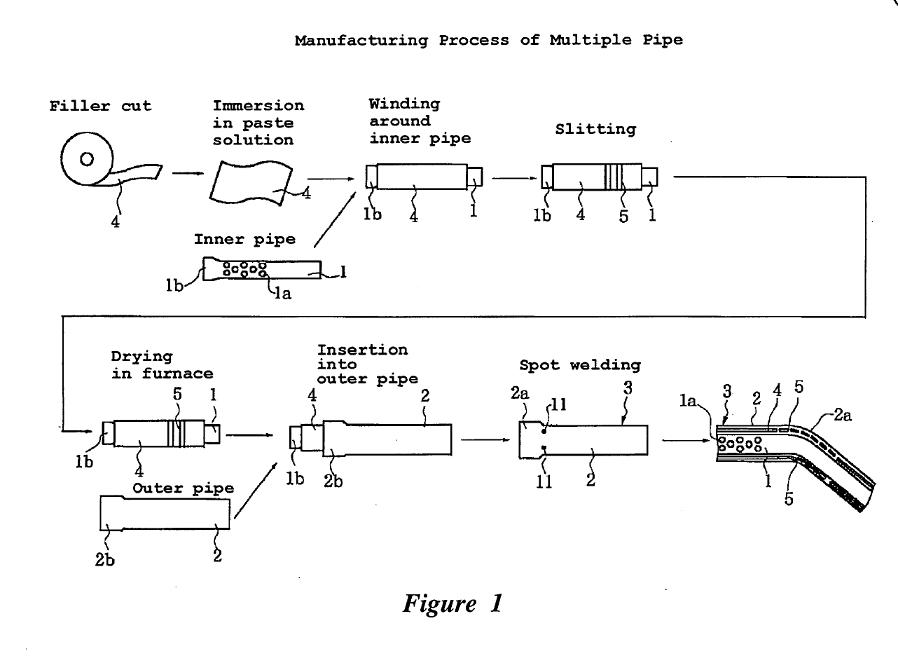

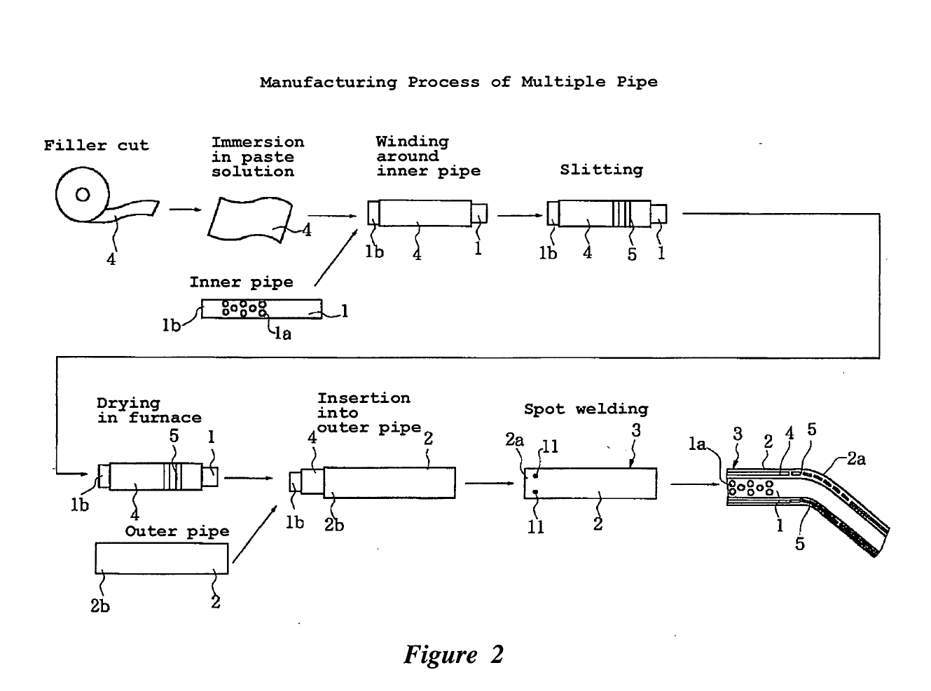

As shown in FIGS. 1 and 2, a material pipe can be formed as a multiple pipe component and, therefore, can be formed by a method of manufacturing such a component. In the embodiment of FIG. 1, an inner pipe 1 is formed with a flare 1b, which generally is flange shaped, and an outer pipe 2 also is formed with a flare 2b, which also generally is flange shaped. In the embodiment of FIG. 2, the flares 1b, 2b are omitted.

A multiple pipe component 3, which can be a double pipe comprising the inner pipe 1 and the outer pipe 2, is a material conveying pipe in the illustrated embodiment. A fibrous filler 4 preferably is disposed between the outer pipe 2 and the inner pipe 1.

The filler 4 can be formed with slits 5 spaced at given pitches in the region where the pipe will be bent. The lengths of the slits 5 are each set to be a desired angle from about 10 degrees to about 180 degrees (i.e., a circumferential angle of about 10 degrees to about 180 degrees where a circumferential angle of 180 degrees is half of the circumference) on both sides of the bend with the filler 4 generally surrounding the inner pipe 1. When the slits are provided only on one side of the bend, they are each set to be a desired angle from about 10 degrees to about 180 degrees or over about 180 degrees.

If the slits 5 are provided on the outer side of the bend, they will open when the pipe is bent so that the likelihood of irregularities or undesired deformation on the outer side of the bend of the outer pipe 2 can be decreased. If the slits 5 are provided on the inner side of the bend, they will overlap each other in the bent state so that the likelihood of bunching of the filler 4, which can create a large swelling on the inner side of the bend, can be reduced. Moreover, by providing the slits or other suitable openings, the likelihood small cracks in the filler forming during bending can be reduced. Thus, when a high quality external appearance is desired only along the outer side of the pipe, the slits 5 can be provided at given pitches in the filler 4 only in the region that will define the outer side of the bend. Similarly, when a high quality external appearance is desired only for the inner side of the bend, the slits 5 may be provided at given pitches in the filler 4 only in the region that will define the inner side of the bend. If a high quality external appearance is desired for both sides of the bend, as in the illustrated embodiment, the filler can be provided with slits spaced at given pitches on both sides of the bend.

Punched holes la are provided on at least one of the downstream side and the upstream side from the portion of the inner pipe 1 that will be bent while no punched holes are disposed in region in which the pipe will be bent so that, after an ice-bending liquid is fed through the holes la, the liquid can be frozen and the pipe can be bent without decreasing the strength of the bent region of the pipe. For instance, if the holes 1a are provided in the inner pipe 1, a large tensile force will be exerted on outer side of the bent portion during bending such that any holes present in this region will become elongated and deformed. In some extreme circumstances, cracks can be produced at the elongated and deformed holes which typically results in breakage of the inner pipe 1. Similarly, a compressive force is exerted on the portion of the inner pipe 1 that is at the inner radius of the bend during bending. Any holes present on the inner radius will likely deform by contracting in the axial direction of the pipe such that the pipe may buckle or fold. Due to the resulting inward bulging of the inner pipe 1, flow resistance through the lumen of the pipe is likely increased or the pipe is likely to develop cracks that begin at the edges of the holes 1a, which likely results in breakage of the inner pipe 1. To reduce the likelihood of these problems, no holes 1a preferably are provided at least in the region of the inner pipe 1 that will be bent, either inner radius or outer radius.

When the multiple pipe component 3 is used as an exhaust pipe, pressure fluctuation of the exhaust gas passing through the inner pipe 1 causes an exhaust noise. Advantageously, the holes 1a provided in the portion of the multiple pipe component 3, excluding the bent portion, will mitigate the pressure fluctuation and reduce the exhaust noise by passing some of the exhaust pressure pulses into the filler that is disposed between the inner pipe 1 and the outer pipe 2. It also has been found that holes can be positioned on the inner radius and/or the outer radius of the bent region if the curvature radius of the bent is sufficiently large and/or the diameter of each hole is small, which reduces the likelihood of the problems described above. The holes 1a for reducing exhaust noise can also be used for the supply of the ice-bending liquid.

As described above, a fibrous filler 4 preferably is disposed between the outer pipe 2 and the inner pipe 1 of the multiple pipe component 3 at the region of the bend, which results in a simplified structure of the bent region of the pipe as well as a high quality external appearance. In addition, when the inner pipe is used as a material conveyance pipe (i.e., without the provision of holes), the pipe will provide a high fluidity of liquids (e.g., less turbulence in the flow).

The illustrated multiple pipe component 3 can be used as an exhaust pipe or the like as described above, and a heat resistant, fibrous and porous filler 4 preferably is disposed between the outer pipe 2 at the pipe bending portion and its inner pipe 1. In the exhaust pipe having the inner pipe 1 serving as an exhaust passage, the filler 4 improves silencing properties and if a catalyst fiber is used, improvement is possible in purifying the exhaust gas, improvement is possible in reducing the heat radiation of the exhaust system, improvements are possible in insulting and/or reducing heat transfer, improvements can be made in sound proofing properties, and the like.

The multiple pipe component preferably is manufactured in accordance with a manufacturing process that is explained below. In general, a fibrous filler 4, which can comprise glass fibers or the like, is cut to a specified length and immersed in a paste solution. Other suitable adhesive or cohesive materials can be applied to the fibrous filler 4 and other techniques of applying the adhesive or cohesive materials can be used. Preferably, the paste ingredient in the paste solution does not readily deteriorate in water or other liquids. In some embodiments, the paste ingredient is selected to be soluble in the freezing liquid to reduce the likelihood of paste deterioration. Holes 1a can be provided in the inner pipe on at least one of the downstream side and the upstream side of the portion of the pipe that will be bent. The fibrous filler 4 can be wound two or three times around the outer circumference of the inner pipe 1.

Using the flange-like flare 1b of the inner pipe 1 as a reference, slits 5 can be cut in the fibrous filler 4 at given pitches. Once prepared in this manner, the pipe can be dried in a furnace. Following drying, the pipe can be inserted into the outer pipe 2. Because the fibrous filler 4 is not broken during insertion, the wrapped and dried inner pipe 1 can be easily inserted into the straight pipe, which improves productivity.

The flange-like flare 1b of the inner pipe 1 preferably is received in the flange-like flare 2b of the outer pipe 2. Once properly positioned, spot welding 11 can be performed to secure the inner pipe 1 in place within the outer pipe 2.

Cutting of the slits 5 may be performed before winding, for example, before immersion into the paste solution. In this case, the positions of the slits 5 relative to the end of the filler 4, the lengths of the slits 5 and the winding position of the end of the filler 4 desirably are controlled to specified values such that the slits 5 will be properly positioned upon wrapping or otherwise applying the filler 4 to the inner pipe 1.

In the inner pipe 1, the holes la preferably are provided on at least one of the downstream side and the upstream side relative to the portion of the inner pipe 1 that will be bent. Preferably, no holes la will be disposed along the portion of the inner pipe 1 that will be bent, which reduces the likelihood of damage to the inner pipe at the portion that will be bent.

As described above, the inner pipe 1 preferably inserted into an outer pipe 2 with a fibrous filler 4 wound around the outside circumference of the inner pipe 1. The multiple pipe component 3 therefore defines a pipe having an inner shell and an outer shell. The ice-bending liquid can be introduced into the space defined between the inner pipe 1 and the outer pipe 2. Once introduced, the ice-bending liquid in the pipe is frozen and the pipe can be bent at the portion where the filler and the ice-bending liquid is disposed. Therefore, a bent pipe can be formed in a relatively inexpensive manner and in a manner that provides a high quality external appearance as well as improve liquid flow characteristics through the lumen defined by the inner pipe.

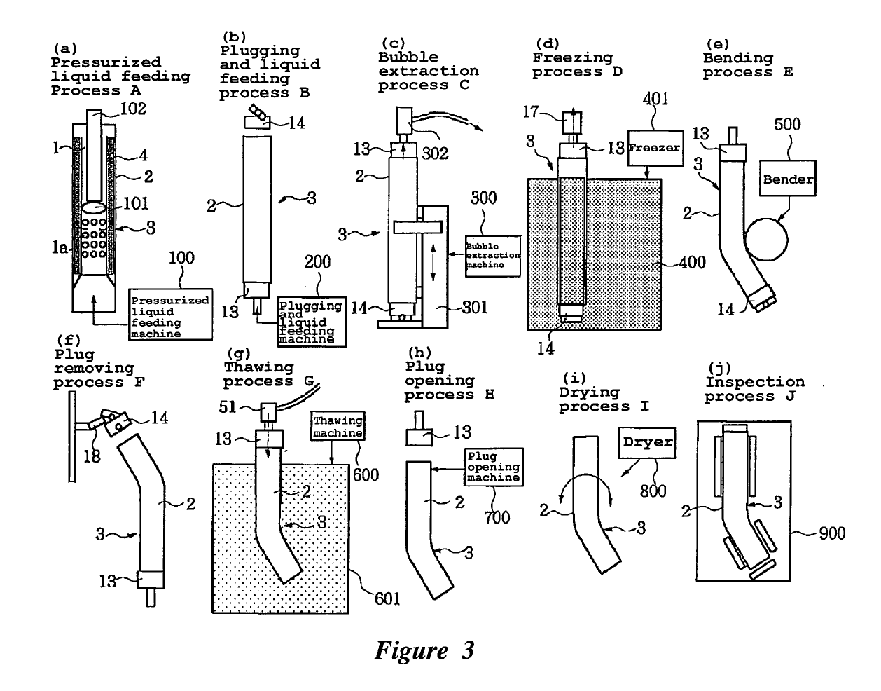

With reference now to FIG. 3, a method of freeze-bending the multiple pipe component is illustrated therein. The method can be used with a material handling pipe, an exhaust system pipe or any other pipe-based component having at least a double wall portion. In the illustrated embodiment, the method features a pressurized liquid introduction process A, a plugging and liquid introduction process B, a bubble extraction process C, a freezing process D, a bending process E, a plug removing process F, a thawing process G, a plug opening process H, a drying process I and an inspection process J. Transfer of the multiple pipe component between processes is performed by an operator in the illustrated configuration, but the multiple pipe component may be automatically transferred between processes using a transfer device.

As shown, in the pressurized liquid introduction process A, an ice-bending liquid is introduced into the assembled multiple pipe component 3 by a pressurized liquid introduction machine 100. The introduction is performed such that the material pipe is raised generally upright, a seal 101 is placed in the inner pipe 1, the seal 101 is pushed down from above with a push rod 102 so as to be positioned in place, thereafter the seal 101 is expanded to create a liquid tight seal against the inside wall of the inner pipe 1, and pressure is applied from under the inner pipe 1. The liquid flows upward from the holes la through the fibrous filler 4 to thereby push out air, which allows the filler 4 to absorb liquid. The pressurized liquid introduction process A comprises a first introduction process into the portion where the filler is disposed.

In the plugging and liquid introduction process B, a coupler-side plug 13 is attached to one end of the multiple pipe component 3 using the plugging and liquid introduction machine 200. The multiple pipe component 3 is raised generally upright with the one end to which the coupler-side plug 13 is attached positioned on the lower end. A clamp-side plug 14 is assembled to the multiple pipe component at the upper end. With the clamp-side plug assembled, a specified amount of ice-bending liquid is introduced at the end of the component 3 to which the coupler-side plug 13 is attached. After the liquid is introduced, while the multiple pipe component 3 is sealed at one end by the clamp-side plug 14, the clamp-side plug 14 is closed such that the liquid is trapped within the multiple pipe component 3.

In the bubble extraction process C, the multiple pipe component 3 is raised upright and mounted on a straight ahead feeder 301 of the bubble extraction machine 300, with the clamp-side plug 14 down. A vacuum drawing coupler 302 is connected to the coupler-side plug 13 and the air is extracted from portion of the multiple pipe component 3 where the filler is disposed. The air extraction advantageously is facilitated by vibrating the component 3 using the straight ahead feeder 301.

Since air is likely to be left in the portion where the fibrous filler 4 is disposed, the pressurized liquid introduction process A may serve also as the bubble extraction process C. That is, increasing the pressure used when introducing the ice-bending liquid from under the inner pipe 1 or decreasing the pressure in the space above the filler 4 by a vacuum pump can be used to improve the bubble extraction.

The plugging and liquid introduction process B comprises a second introduction process to the portion where no-filler is disposed. When the second introduction process to the portion where no-filler is disposed is performed after the first introduction process to the portion where the filler is disposed, the ice-bending liquid can be efficiently introduced into the filler region.

In the freezing process D, an air extraction coupler 17 is connected to the coupler-side plug 13 of the multiple pipe component 3. With the extraction coupler 17 connected, the coupler-side plug 13 can be clamped and suspended. With the component 3 suspended, the multiple pipe component 3 can be put into a freezing tank 400 and the interior of the multiple pipe component 3 can be frozen by a freezer 401. Air pushed out because of volumetric expansion of the ice-bending liquid in association with freezing is discharged from the air extraction coupler 17.

In the bending process E, the frozen pipe formed by the multiple pipe component 3 is bent by a bender 500. Any suitable bending technique can be used.

Following bending in the illustrated embodiment, the clamp-side plug 14 can be removed in a plug removing process F. The clamp-side plug 14 can be caught on a plug remover 18 and the clamp-side plug 14 can thereby be removed by the plug remover 18.

In the thawing process G, a heated liquid-feed plug 51 of a thawing machine 600 is attached to the coupler-side plug 13 of the multiple pipe component 3. In the illustrated arrangement, the multiple pipe component 3 then is put under a heated liquid that preferably is of the same kind as the ice-bending liquid. The heated liquid is contained in a thawing tank 601. Moreover, the heated liquid also preferably is circuited through the multiple pipe component from the heated liquid-feed plug 51.

In the plug opening process H, the coupler-side plug 13 is loosened and removed by a plug opening machine 700.

In the drying process I, the multiple pipe component 3 is rotated by a dryer 800, and the ice-bending liquid, which has permeated in the fibrous filler 4, is removed by centrifugal separation.

In the inspection process J, the bent shape and the like are checked using an inspection device 900.

In the illustrated embodiment, the pressurized liquid introduction machine 100 and the plugging and liquid introduction machine 200 comprise a liquid introduction device for delivering, prior to bending, a liquid into the inner pipe inside the outer pipe at the bending portion and the space between the pipe including the portion where the filler is disposed. The pressurized liquid introduction machine 100 comprises the first liquid introduction machine for delivering a liquid into the portion where the filler is disposed, to the inner pipe at the bending portion and to the space between pipes. The plugging and liquid introduction machine 200 comprises the second liquid introduction machine for delivering the liquid into the portion where no filler is disposed, into the inner pipe at the bending portion and into the space between pipes. Further, the freezing tank 400 and the freezer 401 comprise a freezing device for freezing the liquid after introduction. Further, the thawing machine 600 and the thawing tank 601 constitute a thawing device for thawing the frozen liquid in the multiple pipe component 3 after freezing and after completion of bending by the bender 500.

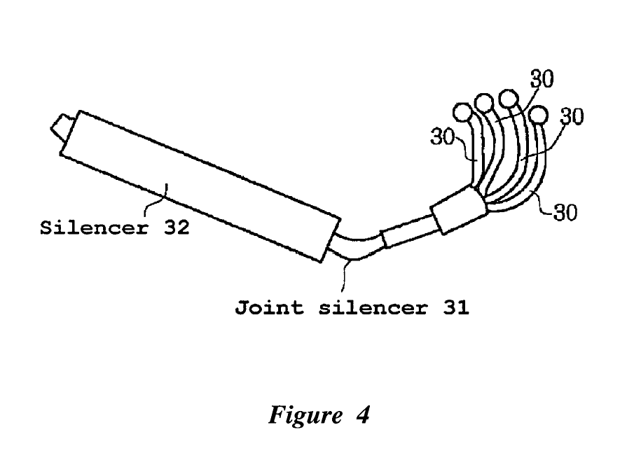

With reference now to FIG. 4, an exhaust pipe used in a motorcycle is illustrated therein. In the illustrated configuration, a plurality of exhaust pipes 30 is connected to a four-cylinder engine of a motorcycle at one end. At the other end, the exhaust pipes 30 are connected to a joint silencer 31. The joint silencer 31, in turn, is connected to a silencer 32.

The joint silencer 31 advantageously is constructed as a multiple pipe component that has a bend. As in the configuration described above, the bent region of the joint silencer 31 preferably does not comprise any holes 1a. Moreover, in the illustrated configuration, slits 5 spaced at given pitches are cut in the filler 4 in the bent region to reduce the likelihood of deformation (in sectional shape) of the outer pipe so that the silencer has a sufficient strength as well as a high quality external appearance. Further, the filler 4 improves the silencing properties and, if catalyst fiber is used, improvement may be possible in purifying the exhaust gases. Further improvement in heat radiation characteristics and heat insulating characteristics can be obtained through material choices for the filler 4.

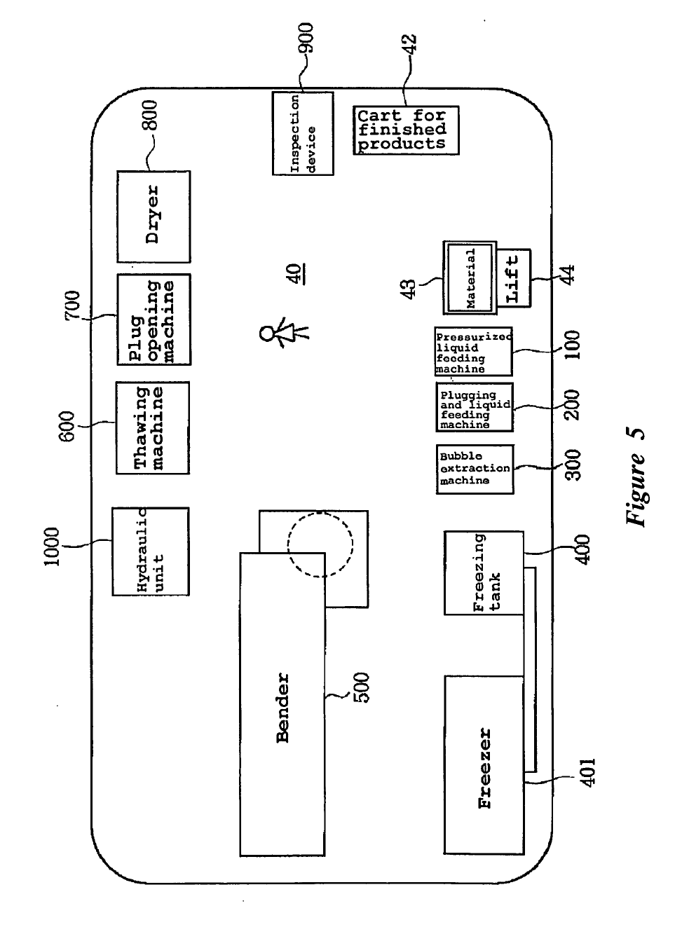

With reference now to FIG. 5, an arrangement for manufacturing multiple pipe components is illustrated therein. In the illustrated arrangement, several components are provided in a factory-like environment. In the illustrated arrangement, a single operator or user is shown; however, any number of operators or users also can work within the environment. In the illustrated arrangement, the following components are shown: a cart for finished products 42, a mesh box pallet 43, a lift 44, a pressurized liquid introduction machine 100, a plugging and liquid introduction machine 200, a bubble extraction machine 300, a freezing tank 400, a freezer 401, a bender 500, a thawing machine 600, a plug opening machine 700, a dryer 800, an inspection device 900 and a hydraulic unit 1000.

In the illustrated arrangement, any suitable number of material pipes formed as unbent multiple pipe components 3 preferably are placed on the mesh box pallet 43. The lift 44 can be a hand lift that is used to transport the mesh box pallet 43 to a desired location. In the illustrated configuration, the operator, after lifting up the mesh box pallet 43 and relocating it to a desired position, puts the pallet 43 in place and moves toward the pressurized liquid introduction machine 100 with the material pipe in hand. Other techniques for loading the pressurized liquid introduction machine 100 also can be used.

The operator transfers the material pipe to the pressurized liquid introduction machine 100, the plugging and liquid introduction machine 200, the bubble extraction machine 300, the freezing tank 400, the bender 500, the thawing machine 600, the plug opening machine 700, the dryer 800 and the inspection device 900. Inspection can be performed with the inspection device 900 of the finished product to evaluate the finished bend. Once inspected, finished bent products are put on the cart for finished products 42 in succession and, when a given number of finished bent products are contained in the cart for finished products 42, the cart 42 is moved into a storage location or otherwise prepared for shipping.

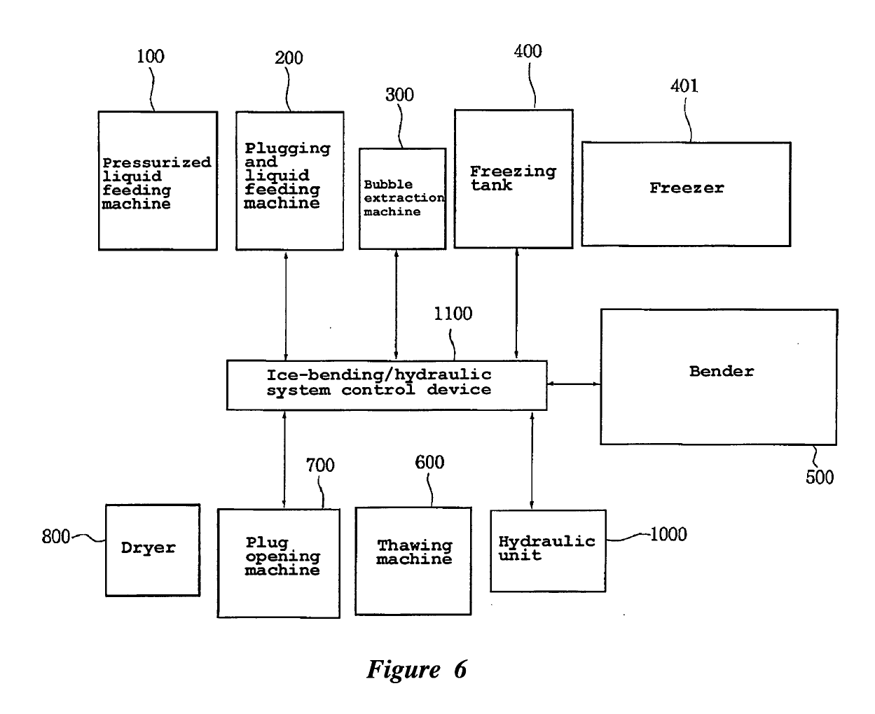

With reference now to FIG. 6, a schematic general control block diagram of a device for manufacturing multiple pipe components is illustrated. In the illustrated manufacturing device for multiple pipe components, the pressurized liquid introduction machine 100, the freezer 401, the thawing machine 600 and the dryer 800 are stand-alone pieces of equipment that are controlled and operated by any suitable control devices. The plugging and liquid introduction machine 200, the bubble extraction machine 300, the freezing tank 400, the bender 500, the plug opening machine 700 and the hydraulic unit 1000 preferably are controlled and operated by an ice-bending/hydraulic system control device 1100.

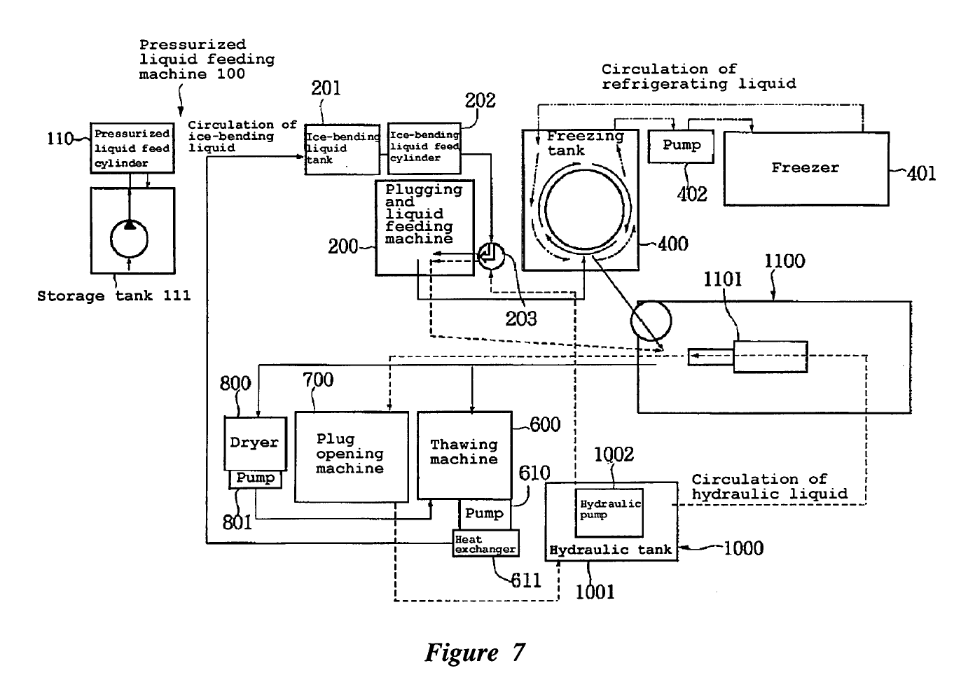

With reference now to FIG. 7, an embodiment of the ice-bending/hydraulic system is shown therein. FIG. 7 also illustrates a flow path through which each of the liquids used in the illustrated embodiment is circulated. In the illustration, an ice-bending liquid flow path is illustrated by solid lines, a hydraulic liquid flow path is illustrated by dotted lines and a freezing brine liquid flow path is illustrated by double dot and dash lines.

As illustrated, in the pressurized liquid introduction machine 100, when a pressurized liquid feed cylinder 110 is actuated by the operator (e.g., through the use of a push-button), an ice-bending liquid is delivered by a pump from a storage tank 111 into the section of the filler 4 in the unbent material pipe of the multiple pipe component 3. The ice-bending liquid is also fed into the inner pipe 1 from an ice-bending liquid tank 201 by the plugging and liquid introduction machine 200, and the material pipe, after completion of bubble extraction by the bubble extraction machine 300, is transported to the insertion section of the freezing tank 400. While immersed in an immersion tank of the freezing tank 400 (e.g., immersed by the operator though a push-button operation or the like), the ice-bending liquid is frozen in place. The material pipe is removed at the exit section of the freezing tank 400 after freezing. The frozen material pipe is transported to the bender 500 (e.g., the operator carries the pipe) and bending is performed (e.g., initiated by a push-button operation or the like). Following bending, the multiple pipe component 3 is transported to the plug removing table for the removal of the clamp-side plug 14. With the plug 14 removed, the component 3 is transported to a thawing tank 601. In other words, the pipe is transferred with the ice-bending liquid contained in the multiple pipe component 3 through each of the machines or stages from the plugging and liquid introduction machine 200 to the thawing tank 601.

In the thawing machine 600, the ice-bending liquid is thawed and the ice-bending liquid flows out from the multiple pipe component 3 into the thawing tank 601. When the pump is operated, the ice-bending liquid in the thawing tank 601 passes through a heat exchanger 611 and, after being cooled down by heat exchange, the liquid is delivered to an ice-bending liquid tank 201. The ice-bending liquid is sent to the plugging and liquid introduction machine 200 from the ice-bending liquid tank 201 through an ice-bending liquid introduction cylinder 202 and through a switch valve 203 in the illustrated configuration.

The multiple pipe component 3, after completion of thawing, is transported to the dryer 800 for removal of the ice-bending liquid that remains in the filler 4. The ice-bending liquid that is separated from the filler 4 in the dryer 800 is collected in the bottom of the dryer 800 and is sent by a pump 801 to the thawing tank 601 of the thawing machine 600. Other arrangements also can be used. A storage tank can be replenished with ice-bending liquid periodically. The storage tank 111 may be eliminated and the function of the storage tank 111 can be integrated into the ice-bending liquid tank 201.

In addition, bending of a single pipe, for example, can be performed using facilities such as those shown in FIG. 5 through FIG. 7, for example but without limitation. In the plugging and liquid introduction machine 200, while air in a single pipe is extracted from hydraulic liquid, such as for example but without limitation, water at a normal or ambient temperature mixed with an antirust or an antimold agent, the hydraulic liquid is fed from the coupler-side plug 13 fitted tightly therein at the lower end. The single pipe can be raised upright and the single pipe receives a different type of plug relative to the clamp-side plug 14 used in the ice-bending process described above. The plug used with the single pipe preferably can be tightly fit in the single pipe at the upper end. More preferably, the plug seals the upper end of the single pipe. The plug also has a hydraulic liquid passage through which liquid can be introduced into and removed from the single pipe. In one preferred configuration, the plug comprises a hydraulic passage at the center and a valve that is used to open/close the passage.

With reference to FIG. 5, when the liquid is begins to leak out of the plug, the air likely has been sufficiently extracted and the valve is closed. Following the introduction of the liquid, the single pipe can be transported to the bender 500. At the bender 500, a coupling pipe of the hydraulic unit 1000 can be connected to the coupler-side plug 14 and bending can be performed while the liquid pressure in the single pipe is controlled by the hydraulic unit 1000. Preferably, the liquid pressure is controlled as the bending occurs but the liquid pressure also can be controlled before and after the bending operation.

The single pipe, after completion of bending, can be transported to the plug opening machine 700. At the plug opening machine, the clamp-side plug 14 at one end and the other plug are in turn removed. With the plugs removed, the hydraulic liquid in the single pipe flows out of the pipe into the plug opening machine 700 and returns to the hydraulic tank 1001 (see FIG. 7) from the bottom of the plug opening machine 700 in the illustrated configuration. The return of the liquid advantageously is effected by gravity due to a height difference. In some configurations, the liquid can be returned by a pump.

The hydraulic pump 1002 preferably removes some of the hydraulic liquid from the hydraulic tank 1001 when the liquid is being introduced into the work piece in the plugging and liquid introduction machine 200. At this time, a changeover from the ice-bending liquid to the hydraulic liquid can be performed by the switch valve 203.

As illustrated, the freezing brine liquid can be circulated between the freezer tank 400 and the freezer 401 by a pump 402. Other suitable configurations also can be used.

With reference now to FIG. 5 and FIG. 7, in the illustrated manufacturing device, the pressurized liquid introduction machine 100, the plugging and liquid introduction machine 200, the bubble extraction machine 300, the freezer tank 400 and the freezer 401 advantageously are compactly arranged on one side of the bender 500, and the hydraulic unit 1000, the thawing machine 600, the plug opening machine 700, the dryer 800 and the inspection device 900 advantageously are arranged on the other side.

The bubble extraction machine 300 provides improved air extraction from the multiple pipe component 3. Improved air extraction greatly reduces the likelihood of defects at the time of bending, such as irregularities due to collapsing or a hollow and the like on the outer side of the bend, and inward shrinkage due to buckling or outward folds due to bulging on the inner side of the bend.

It is contemplated that the functions of at least some of the machines can be integrated into other machines. For instance, if at least one of the plugging and liquid introduction machine 200, the bender 500 and the plug opening machine 700 serves as another machine, the cost of equipment can be reduced. For instance, the hydraulic unit 1000 is disposed near the bender 500 in the illustrated configuration. During high pressure-bending of a single wall pipe, the pipe can be connected to the hydraulic unit 1000 such that the interior of the pipe can be pressurized when the bender 500 is operated. During freeze-bending of the pipe, however, the material pipe is not pressurized by the hydraulic unit 1000 but the bender 500 operates as the hydraulic unit thereby reducing the cost of equipment.

Moreover, the circulation path of the hydraulic liquid for pressure-bending and that of the ice-bending liquid for freeze-bending advantageously are formed independently of each other. Also, the hydraulic liquid for pressure-bending and the ice-bending liquid for freeze-bending preferably are liquids with compositions different from each other. For example, but without limitation, the hydraulic liquid is water and the ice-bending liquid is water mixed with propylene glycol. Accordingly, the ice-bending liquid is relatively stable in hardness at the time of freezing and, when a bending load is applied, the ice can be readily broken into relatively small pieces, which increases the fluidity of the liquid such that the likelihood of irregularities on the inner or outer side of the bend of the multiple pipe component 3 is greatly reduced. Moreover, the freezing temperature is lowered to improve working efficiency. In some situations, however, if the hydraulic liquid and the ice-bending liquid have the same composition, control and operation of the facility is simplified.

With reference to FIG. 7, the ice-bending liquid preferably can be fed to the section of the filler 4 in the multiple pipe component 3 from the storage tank 111 that is in communication with the pressurized liquid introduction machine 100 independent from the circulation path of the ice-bending liquid for freeze-bending.

With continued reference to FIG. 7, the circulation path of the ice-bending liquid preferably comprises a circulation path in which the ice-bending liquid is transported inside of the substantially sealed work piece among the plugging and liquid introduction machine 200, the bubble extraction machine 300, the freezing tank 400, the freezer 401, the bender 500 and the thawing machine 600, where it flows out into the thawing tank 601 from inside the work piece. From the thawing tank 601, the ice-bending liquid is conveyed to the ice-bending liquid tank 201.

When ice-bending liquid is supplied to the work piece from the storage tank 111, the amount of ice-bending liquid in the storage tank 111 decreases. Accordingly, an operator can replenish the storage tank 111 with flesh ice-bending liquid or the supply can be automatically replenished. The restocking or replenishing of the ice-bending liquid also accounts for both the evaporation losses that may occur in any portion of the process in which the ice-bending liquid is exposed to the atmosphere (e.g., in the middle of the circulation path) and the losses that may occur because the removal process is not fully efficient and the ice-bending liquid may not be completely removed from the finished bent multiple pipe components 3.

With respect to the hydraulic liquid that is used during pressure-bending (e.g., single wall products), the hydraulic liquid can be fed from the hydraulic tank 1001 into the work piece which has plugs inserted in each end. Of course, similar to the ice-bending liquid, the circulation path of the hydraulic liquid comprises portions in which the hydraulic liquid is carried inside of the work piece to the bender 500 and the plug opening machine 700, where it flows out from inside the material pipe, and thereafter is returned to the hydraulic tank 1001. Because the circulation path is largely, if not completely, enclosed or contained without substantial exposure to the atmosphere and because the hydraulic liquid is not necessarily in contact with a fibrous member, smaller losses of the hydraulic liquid are experienced relative to the ice-bending liquid.

As described above, in embodiments featuring both pressure bending and freeze bending through a single machine (e.g., the plugging and liquid introduction machine 200) each of the hydraulic tank 1001 and the ice-bending liquid tank 201 advantageously can be connected to the respective introduction ports of the plugging and liquid introduction machine 200 through the switch valve 203. Accordingly, a single machine can perform two otherwise separate operation and the cost of equipment can be reduced.

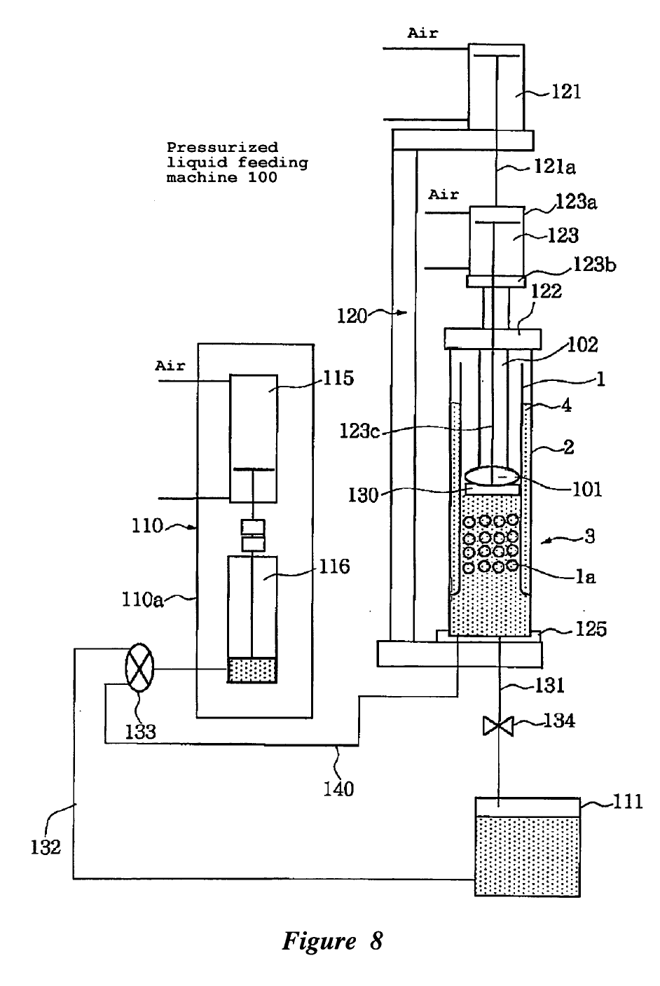

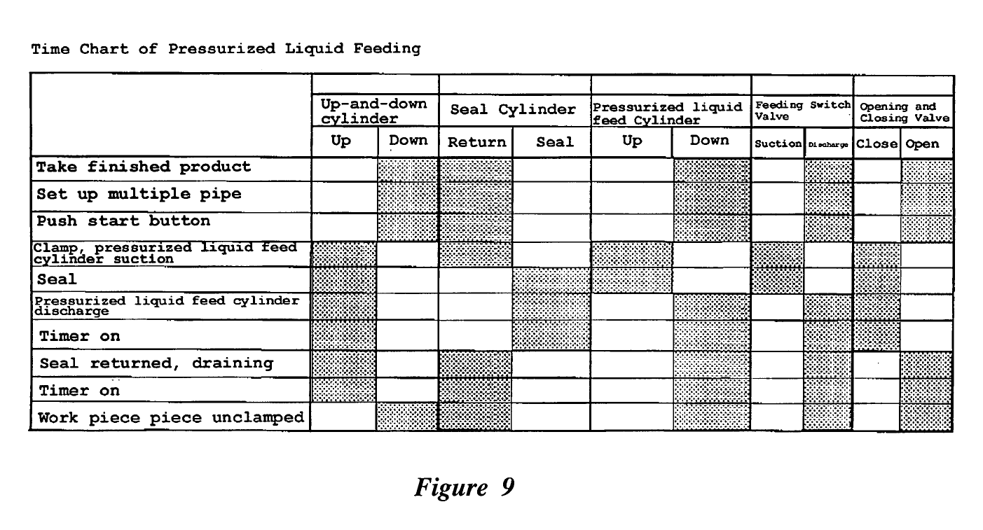

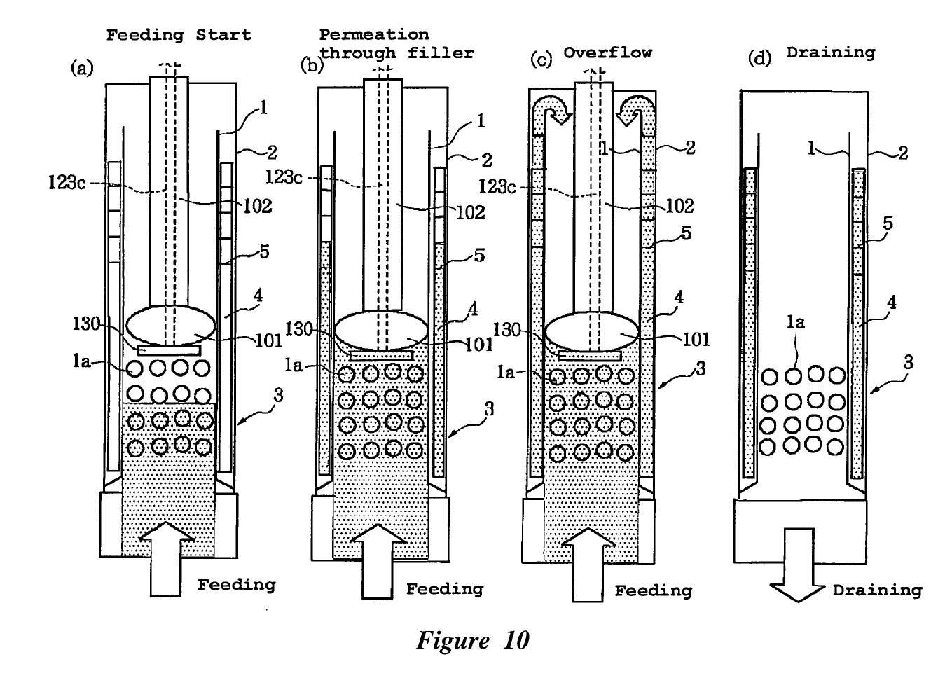

With reference now to FIG. 8 through FIG. 10, an example of a pressurized liquid introduction machine is illustrated therein. FIG. 8 is a schematic structural view of the pressurized liquid introduction machine, FIG. 9 is a time chart of pressurized liquid introduction of the ice-bending liquid, and FIGS. 10(a) through 10(d) are views illustrating the introduction of the ice-bending liquid into a work piece.

In the illustrated pressurized liquid introduction machine 100, the multiple pipe component 3 is set vertically on a work piece holding unit 120. In some embodiments, the component 3 can be somewhat inclined such that it comprises a lower end and an upper end. It is believed that the more vertical the component is positioned, however, the more efficiently the operation can be performed. The work piece holding unit 120 moves up and down through an up-and-down cylinder 121. When the work piece holding unit 120 is in the up position, the component 3 has been mounted for introduction of the liquid. When the work piece holding unit 120 is in the down position, the component 3 can be positioned on the work piece holding unit 120 or can be removed from the work piece holding unit 120.

As illustrated, the work piece holding unit 120 preferably comprises a piston rod 121a of the up-and-down cylinder 121, a sealing cylinder 123, a stopper 122, a seal 101, and the like. The illustrated piston rod 121a generally comprises a piston and a rod. A cylinder 123a of the sealing cylinder 123, a cylinder cap 123b, the stopper 122 and a push rod 102 preferably are coupled together into a generally integral unit A piston rod 123c preferably comprises a piston and a rod of the sealing cylinder 123. The rod preferably penetrates the cylinder cap 123b, a stopper 122, a push rod 102 and a seal 101. The rod preferably is coupled integrally to a plate 130.

When the piston of the up-and-down cylinder 121 is moved down, the integrated component defined by the piston 121a, the cylinder 123a, the cylinder cap 123b, the stopper 122 and the push rod 102 preferably is moved down. When the integrated component moves down the seal 101 preferably is inserted into the multiple pipe component 3 while the multiple pipe component 3 is pressed downward by the stopper 122. The stopper 122 preferably is provided with a notch or a through-hole to allow air from inside the multiple pipe component 3 to escape to the outside.

The piston of the sealing cylinder 123 then is moved upward to pull up the plate 130 through the piston rod 123c so that the plate 130 squeezes the seal 101, which expands in width such that it tightly abuts the inner pipe 1 of the multiple pipe component 3.

With the multiple pipe component 3 mounted on the work piece holding unit 120 in the manner described above, the ice-bending liquid can be supplied to the component 3. For this purpose, a feed pipe 140 and a return pipe 131 are connected to the bottom of the inner pipe 1 through a base plate 125. A pressurized liquid feed cylinder 110 is connected to the feed pipe 140 through an introduction switch valve 133. The pressurized liquid feed cylinder 110 also is connected to the return pipe 131, a storage tank 111, a return pipe 132 and an introduction switch valve 133. The introduction switch valve 133 comprises a three-way valve and preferably is switchable between the suction side and the discharge side.

An opening and closing valve 134 preferably is disposed in the return pipe 132. The opening and closing valve 134 can be when the liquid is being introduced. After introduction, the valve can be switched open so that the ice-bending liquid in the inner pipe 1 can be returned to the storage tank 111.

The pressurized liquid feed cylinder 110 preferably comprises an air cylinder section 115 and a pressure cylinder section 116. Cylinders of both cylinder sections 115, 116 can be fixed to a base 110a, and pistons of both cylinder sections 115, 116 can be coupled to a single rod so that the cylinder section 116 is driven in association with the air cylinder section 115.

As shown in FIG. 9, the piston of the up-and-down cylinder 121 moves up; then the piston inside the sealing cylinder 123 returns; then the piston inside the pressurized liquid feed cylinder 110 moves down; and when the introduction switch valve 133 is on the discharge side and the opening and closing valve 134 is closed, the work piece can be inserted into the pressurized liquid introduction machine 100. Once mounted, the machine can proceed (e.g., the start button can be pushed).

The piston inside the up-and-down cylinder 121 then moves down; the piston inside the pressurized liquid feed cylinder 110 moves up; the introduction switch valve 133 is switched to the suction side and the opening and closing valve 134 is switched open. Accordingly, the work piece is clamped and the pressurized liquid feed cylinder 110 draws the ice-bending liquid from the storage tank 111 through the return pipe 132 and the introduction-switch valve 133 into the pressure cylinder section 116.

Then, the sealing cylinder 123 is actuated. The work piece is plugged inside with the seal 101 at a position further upward than the holes la. With the work piece sealed, the introduction-switch valve 133 is switched to the discharge side and the opening and closing valve 134 is closed. When the pressurized liquid feed cylinder 110 is actuated in the discharge side mode, the ice-bending liquid is fed through the introduction-switch valve 133 and the feed pipe 140 into the interior of the multiple pipe component 3 from below. Pressurized introduction of the ice-bending liquid causes the ice-bending liquid to flow upward from the holes la through the fibrous filler 4 so that air is pushed out and the ice-bending liquid can be absorbed into the filler 4.

Preferably, the introduction of the ice-bending liquid is performed over a predetermined time. A timer can be used to control the length of time over which ice-bending liquid impregnation occurs. The piston in the sealing cylinder 123 can be returned and the opening and closing valve 134 can be switched to open. With the timer on, The ice-bending liquid also can be drawn out from the multiple pipe component 3 for a specified time (e.g., a timer can be used).

The piston of the up-and-down cylinder 121 moves upward and the clamping of the work piece can be released.

With reference now to FIG. 10, when the pressurized introduction of the ice-bending liquid begins, (FIG. 10(a)), the ice-bending liquid enters the fibrous filler 4 through the holes 1a. Because the multiple pipe component 3 is blocked inside of the inner pipe 1 at a position further upward than the holes 1a (FIG. 10(b)) with the seal 101, the ice-bending liquid pushes out air and permeates through the fibrous filler 4.

When the ice-bending liquid pushes out air, permeates through the filler 4 and overflows (FIG. 10(c)), the seal 101 can be removed, and the opening and closing valve 134 can be switched. The fibrous filler 4 thereby has been impregnated with the ice-bending liquid, which is retained in the fibrous filler 4.

In the illustrated configuration, the fibrous filler 4 preferably is disposed in the multiple pipe component 3 at a portion that will be bent. The filler is positioned between the outer pipe 2 and the inner pipe 1 with the holes 1a being provided in the inner pipe 1 on at least one of the downstream side and the upstream side of the portion that will be bent and with no holes 1a being positioned in the pipe bending portion 1b.

In the illustrated arrangement, the multiple pipe component 3 has the fibrous filler 4 disposed at the pipe bending portion between the outer pipe 2 and its inner pipe 1. With the introduction of the ice-bending liquid, air still may be left in the fibrous filler 4. Even if the multiple pipe component 3 is fed from below in the manner described above, all of the air in the multiple pipe component 3 is not likely removed. Accordingly, in the illustrated configuration, only the fibrous filler 4 is impregnated and introduction to the central part of the multiple pipe component 4 is performed in another step.

To fill the remainder of the work piece, the lower end of the fibrous filler 4 is closed tightly by spot-welding the outer pipe 2 to the inner pipe 1 and the work piece is plugged at the side on which the work piece is closed by the inner pipe 1, with the base plate 125 on the work piece holding unit 120 and having a packing, as shown in FIG. 8. The feed pipe 140 and the return pipe 131 are connected to the base plate 125.

The seal 101 can be removed and the material pipe can be carried to the plugging and liquid introduction machine 200. In the illustrated configuration, the plugging and liquid introduction machine 200 is positioned adjacent to the pressurized liquid introduction machine 100. To reduce the likelihood of the ice-bending liquid being released from the fibrous filler 4, the work piece should be transferred without subjecting it to significant shocks.

The multiple pipe component 3 preferably is inclined to substantially the vertical direction or raised generally upright and the region between the outer pipe 1 and the inner pipe 2 opens at a position further upward than the portion where the filler 4 is disposed. In this orientation, the inner pipe 1 preferably is blocked with a seal 101 at a location vertically higher than the holes 1a. The outer pipe 2 preferably is plugged 8 at the lower end and the ice-bending liquid (i.e., a liquid for freezing) is supplied under pressure through the plug 8. As the liquid is being introduced, the ice-bending liquid flows from the holes 1a through the portion where the filler 4 is disposed and overflows from the opening 7, and it pushes out air from the portion where the filler is disposed, and permeates through the filler 4. After the foregoing introduction of liquid, the seal 101 is removed and the ice-bending liquid is drained. The inner pipe 1 is subsequently supplied with ice-bending liquid by the plugging and liquid introduction machine 200 and the multiple pipe is frozen for the bending. Therefore, air is pushed out from the portion where the filler is disposed, which reduces the likelihood that significant pockets of air will remain during the bending operation after the liquid is frozen. Thus, deformation of the inner pipe and/or the outer pipe can be performed with less defects resulting.

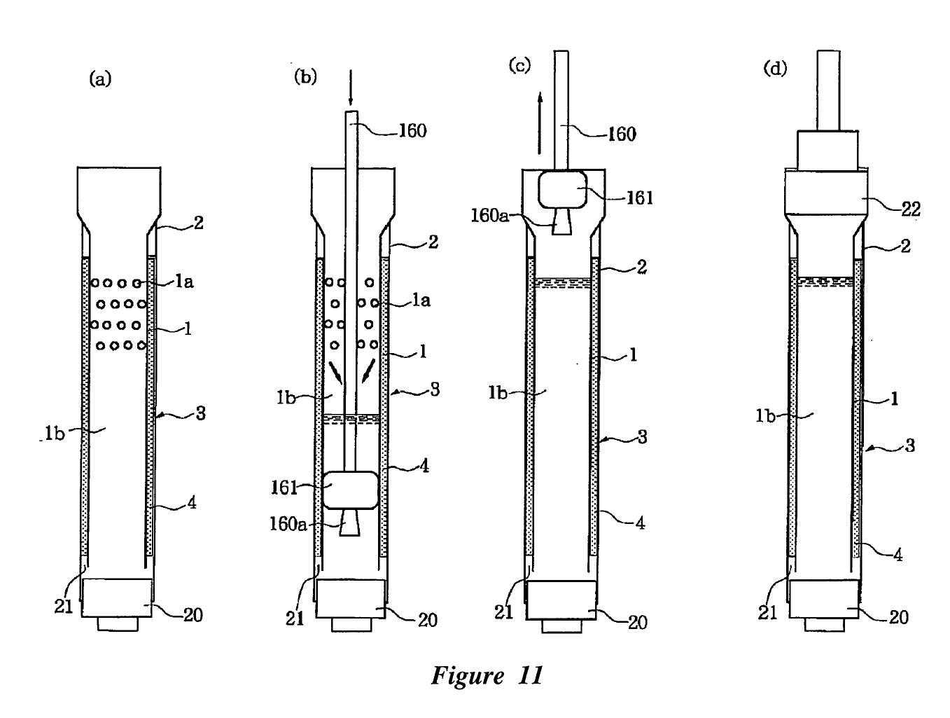

With reference now to FIG. 11, another arrangement is illustrated whereby pressurized liquid can be introduced to the multiple pipe component 3. As illustrated, the multiple pipe component 3 first is disposed generally vertically or substantially upright but in the opposite orientation relative to the arrangement of FIG. 10. The outer pipe 2 preferably is plugged 20 at the lower end (FIG. 11(a)).

A seal 161 that is penetrated by an introduction nozzle 160 can be inserted in the inner pipe 1 of the multiple pipe component 3. The seal preferably is inserted from a location vertically higher than the holes la but is inserted to a location that is generally vertically lower than the holes 1a. The ice-bending liquid can be supplied to the inside of the inside pipe 1 through the introduction nozzle 130. When the surface of the ice-bending liquid rises beyond the seal 161, the introduction nozzle 160 is pulled up to thereby expand the seal 161 by a taper 160a at the lower end of the introduction nozzle 160, and the inner pipe 1 is thereby plugged. When the inner pipe 1 is plugged and the ice-bending liquid is fed from the introduction nozzle 160, the liquid flows from an opening 21 between the outer pipe 2 and inner pipe 1 through the portion where the filler 4 is disposed. In the illustrated arrangement, the opening 21 is positioned vertically lower than the position where the filler 4 is disposed. As the liquid reaches the holes 1a, the liquid enters the inner pipe 1 and begins to fill the inner pipe 1 atop of the seal 161 (FIG. 11(b)).

When the ice-bending liquid is supplied up to a position upward of the holes 1a, the taper 160a is retracted from the seal 161 which allows the seal to retract from the inner pipe 1, and the introduction nozzle 160 is pulled up. Additional ice-bending liquid then is supplied to compensate for the amount that the liquid surface has fallen (FIG. 11(c)). The introduction nozzle 160 then is removed and the multiple pipe component 3 is plugged 22 at the upper end (FIG. 11(d)).

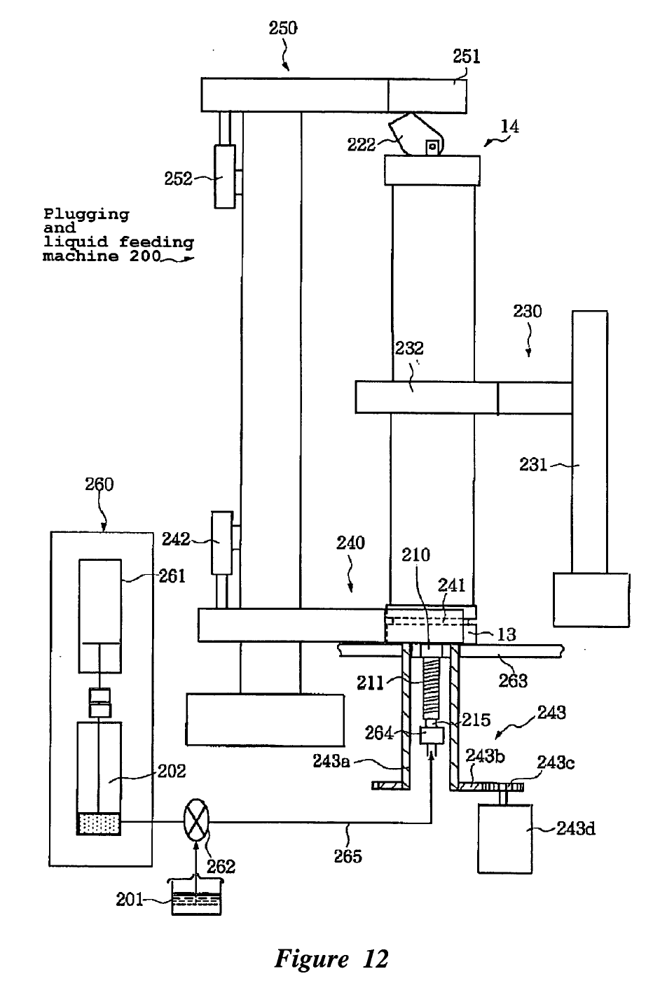

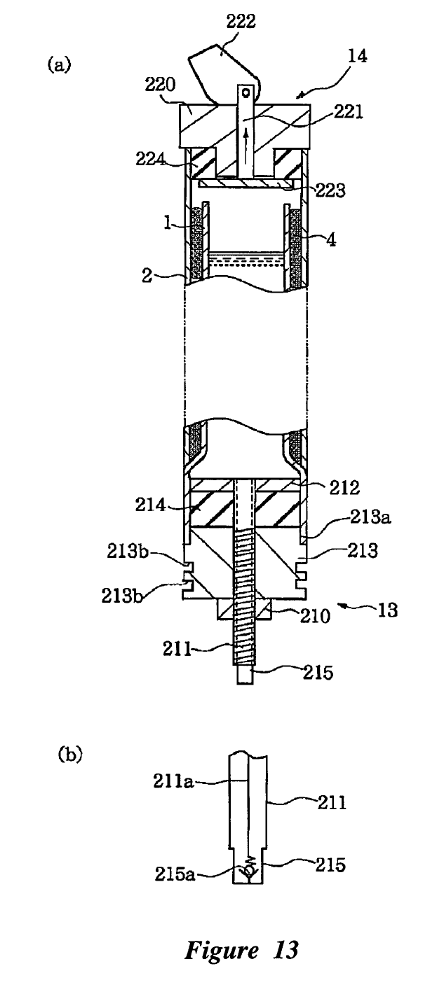

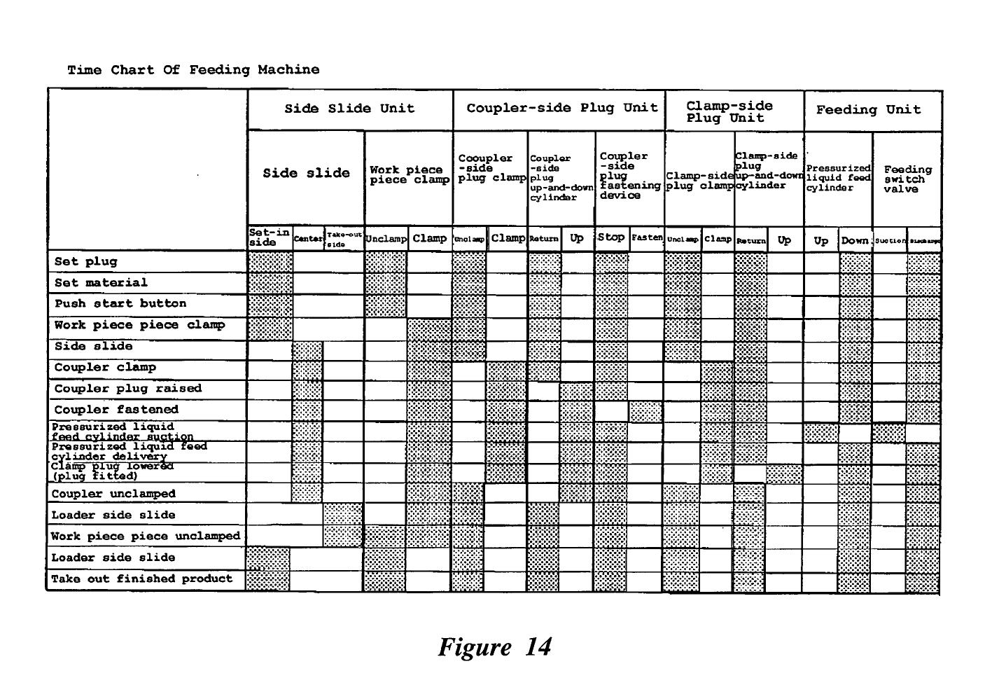

FIG. 12 through FIG. 14 show a preferred configuration of the plugging and liquid introduction machine 200. FIG. 12 is a schematic structural view of the plugging and liquid introduction machine, FIG. 13 is a view showing a plugging structure, and FIG. 14 is an operational time chart of the illustrated plugging and liquid introduction machine.

In the illustrated configuration, the plugging and liquid introduction machine 200 comprises a side slide unit 230, a coupler-side plug unit 240, a clamp-side plug unit 250, and an introduction unit 260. The side slide unit 230 comprises a side slide 231 and a work piece clamp 232. The work piece clamp 232 secures and releases the multiple pipe component 3. The work piece clamp 232 moves the multiple pipe component 3 with the side slide 231 to an insertion side, to a center position and to a removal side while the multiple pipe component 3 is secured.

The coupler-side plug unit 240 comprises a coupler-side plug clamp 241, a coupler-side plugging up-and-down cylinder 242 and a coupler-side plug fastening device 243. The coupler-side plug clamp 241 secures and releases a coupler-side plug 13 that is positioned on a mount 263. The coupler-side plugging up-and-down cylinder 242 moves the coupler-side plug clamp 241 up and down and attaches the coupler-side plug 13 to one end of the multiple pipe component 3.

The coupler-side plug fastening device 243 comprises a nut driver 243a adapted to be fitted on the nut 210 and a pinion 243c that meshes with a gear 243b of the nut driver 243a. The coupler-side plug fastening device 243 also comprises a motor 243d that rotates the nut driver 243a. When the nut 210 is tightened, the coupler-side plug 13 is tightly secured in the multiple pipe component 3. The coupler-side plug unit 240 also preferably comprises an up-and-down moving device (not shown) that moves the coupler-side plug fastening device 243 up and down and a female coupler 264 that is fitted on a male coupler 215 formed at the end of the coupler-side plug 13.

The clamp-side plug unit 250 comprises a clamp-side plug clamp 251 and a clamp-side plugging up-and-down cylinder 252. The clamp-side plug clamp 251 secures and releases a clamp-side plug 14. The clamp-side plugging up-and-down cylinder 252 moves the clamp-side plug clamp 251 up and down and attaches the clamp-side plug 14 to the other end of the multiple pipe component 3.

As for the coupler side plug 13, as shown in FIG. 13, when a cap 213 is rotated, a screw 213a is fitted in the end portion of the multiple pipe component 3. A hollow bolt 211 is inserted in the cap 213, and when the nut 210 fitted on the hollow bolt 211 is rotated, a pressing plate 212 is pulled toward the cap 213 by the hollow bolt 211. A seal 214 is pressed between the pressing plate 212 and cap 213. This squeezing causes the seal 214 to expand outward to be press-fit against the inside wall of the multiple pipe component 3. With the seal 214 in place, the ice-bending liquid can be held in a sealed relation. In the male coupler 215 formed at the end of the hollow bolt 211, a check valve 215a is provided with closed by a spring, which closes a passage 211a in the hollow bolt 211. When the female coupler 264 is fitted on the male coupler 215, the check valve 215a is pushed open by the female coupler 264, which connects the passage 211a to another passage (not shown) in the female coupler 264 such that the ice-bending liquid can be fed into the interior of the multiple pipe component 3 from the female coupler 264 through the passage 211a.

Preferably the cap 213 comprises engagement grooves 213b, 213b that allow the for clamping and suspending the cap 213.

The clamp-side plug 14 comprises a cam lever 222 that is mounted to a rod 221. The cam lever 222 can pivot relative to the end of the rod 221 that is inserted in the cap 220. When the cam lever 222 is pressed down, the cam lever 222 pulls the rod 221 upward by cam action and a pressing plate 223, which is connected to the rod 221, is pulled toward the cap 220. The seal 224 is pressed between the pressing plate 223 and cap 220 and this pressing causes the seal 224 to expand outward to be press-fit against the inside wall of the multiple pipe component 3. In this manner, the ice-bending liquid can be held in a sealed relation inside of the multiple pipe component.

The introduction unit 260 comprises a feed cylinder 200 and an introduction switch valve 262. The introduction unit 260 further comprises a mount 263 for one end (e.g., on the side to which the coupler-side plug 13 is connected) of the material pipe formed by the multiple pipe component 3. The unit 260 also comprises a female coupler 264 that is used to clamp the material pipe and a feed pipe 265 that moves together with the coupler-side plug fastening device 243 from under the material pipe with the up-and-down moving device (not shown). Preferably, the feed pipe 265 is provided with the female coupler 264 fitted on the male coupler 215.

The feed cylinder 202 comprises a piston that moves up to draw ice-bending liquid from an ice-bending tank 201 through the introduction switch valve 262 and the piston moves down to discharge the ice-bending liquid through the introduction switch valve 262. The feed cylinder 202 supplies the interior of the multiple pipe component 3 with a specified amount of ice-bending liquid through the coupler-side plug 13. The introduction switch valve 262 is capable of switching between the suction side (i.e., communication of the feed cylinder 202 and the ice-bending liquid tank 201) and the discharge side (i.e., communication of the feed cylinder 202 and the feed pipe 265).

The introduction unit 260 preferably comprises an air cylinder 261. The air cylinder 261 drives the feed cylinder 202 by creating movement of the piston of the feed cylinder 202.

In the plugging and liquid introduction machine 200, as shown in FIG. 14, a material pipe formed by the multiple pipe component 3 is set up on a support table (not shown), the coupler-side plug 13 is set up on the mount 263, and the clamp-side plug 14 is set up on the clamp-side plug clamp 251. Once mounted, the operation of the machine 200 can begin (e.g., the operator can push the start button (not shown)). The work piece clamp 232 holds the material pipe formed by the multiple pipe component 3 and the side slide 231 is actuated to move it to the center position.

The coupler-side plug clamp 241 holds the coupler-side plug 13, the clamp-side plug clamp 251 holds the clamp-side plug 14, the coupler-side plug clamp 241 is raised by the coupler-side plug up-and-down cylinder 242 so that the coupler-side plug 13 is received by the multiple pipe component 3 at the lower end, and the coupler-side plug clamp 241 is raised so that the multiple pipe component 3 is secured at the upper end on the clamp-side plug 14, which is held by the clamp-side plug clamp 251. The female coupler 264 can be raised by the up-and-down moving device (not shown) such that it is received in the male-side coupler 215, the coupler-side plug fastening device 243 is raised, and the nut 210 is fastened by the coupler-side plug fastening device 243 so that the coupler-side plug 13 is secured to the lower end of the multiple pipe component 3.

The introduction switch valve 262 is switched to the suction side to raise the feed cylinder 202 and the ice-bending liquid is drawn through the introduction switch valve 262. The feed cylinder 202 is lowered to discharge the ice-bending liquid through the introduction switch valve 262, and a specified amount of ice-bending liquid is fed into the interior of the multiple pipe component 3 from the side of the coupler-side plug 13.

After the liquid is supplied, the clamp-side plug up-and-down cylinder 252 is lowered, the clamp-side plug clamp 251 is moved downward, and the cam lever 222 is pushed down so that the clamp-side plug 14 is fitted tightly to the upper end of the multiple pipe component 3.

Then, the coupler-side plug clamp 241 is lowered and the coupler-side plug 13 is released; the clamp-side plug clamp 251 is raised without holding the clamp-side plug 14; the side slide 231 is actuated to move from the center position to the removal position and the work piece clamp 232 releases the multiple pipe component 3. The operator then can remove the finished product of the material pipe formed by the multiple pipe component 3 and the side slide 231 can then returned to the initial position (i.e., the insertion or loading position) and the procedure is terminated.

In the illustrated configuration, the plugging and liquid introduction machine 200 introduces a specified amount of the ice-bending liquid. The specified amount can be set by a touch panel. The specified amount can be drawn into and discharged from the feed cylinder 202 like the water gun. Therefore, the multiple pipe component 3 is not filled with the ice-bending liquid and the volumetric expansion is small. A specified amount of ice-bending liquid is fed by the feed cylinder 202, thereby improving working efficiency of ice-bending liquid supply.

Introduction of a specified amount of ice-bending liquid may be performed by detecting the outflow of the ice-bending liquid from the clearance between the clamp-side plug 14 on the upper side and the inside wall of the multiple pipe component 3, or the opening to the atmosphere, and the feed cylinder 202 can then be stopped.

Further, the clamp-side plug 14 in this embodiment is of a one-touch opening/closing type operated by cam action through the cam lever 222 provided at one end (e.g., on the side of pressurized liquid introduction at the time of introduction) of the multiple pipe component 3, improving working efficiency. Further, since the coupler-side plug 13 is attached to the other end (e.g., on the side of vacuum-drawing at the time of introduction, the side of suspension at the time of freezing and thawing) of the multiple pipe component 3, it can be used also as a suspension device, and working efficiency in setting up the air piping is improved, as well as thawing properties.

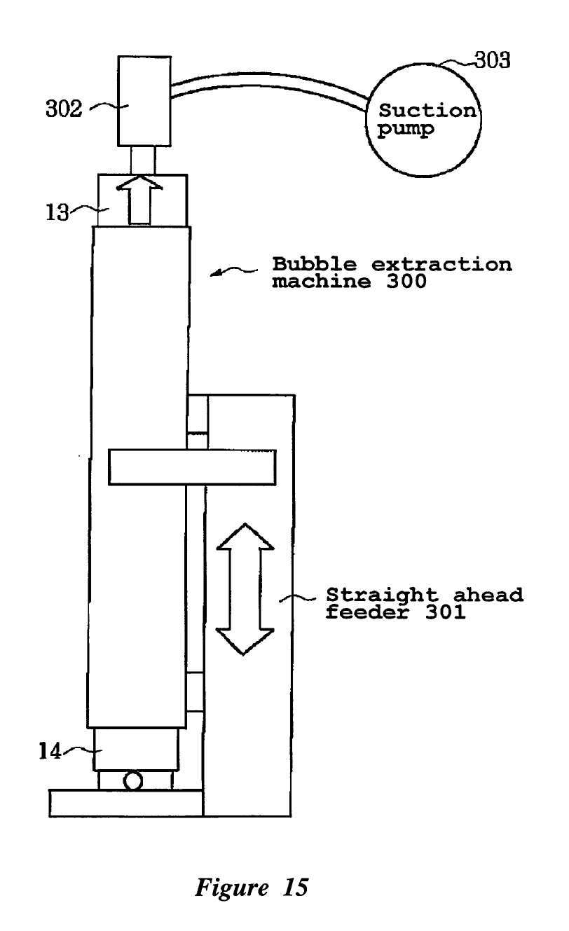

With reference to FIG. 15, a bubble extraction machine is illustrated therein. In the illustrated bubble extraction machine 300, air remaining in the filler 4 can be removed. Preferably, the multiple pipe component 3 in which the clamp-side plug 14 and the coupler-side plug 13 are secured is set on a straight ahead feeder 301, with the clamp-side plug 14 down and the coupler-side plug 13 up.

A vacuum-drawing coupler can comprise a female coupler that is adapted to open the check valve 215a of the male-side coupler 215 of the coupler-side plug 13. The vacuum-drawing coupler also can comprise a suction pump 303 that is connected to the vacuum-drawing coupler 302 and the upper part of the multiple pipe component 3 can be depressurized by the suction pump 303. Vibration is applied by the straight ahead feeder 301 to extract air in the portion of the multiple pipe component 3 where the filler is disposed. Reliable air extraction is possible by rapidly reciprocating (i.e., applying vibration to) the multiple pipe component 3 that has been supplied with the ice-bending liquid. By removing large air pockets, improved bending performance can be obtained.

As described above, the multiple pipe component 3 can be plugged at the lower end with a clamp-side plug 14, and the multiple pipe component 3 can be inclined to the substantially vertical direction or can be raised generally upright, and vibrated to improve bubble extraction. Therefore, air can be extracted reliably and, when the pipe is bent with the ice-bending liquid frozen, imperfections in the bend (i.e., at the surfaces of the inner and outer pipes) can be greatly reduced.

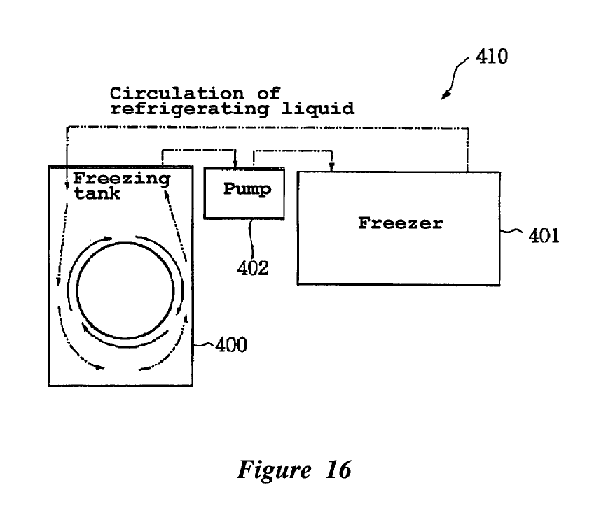

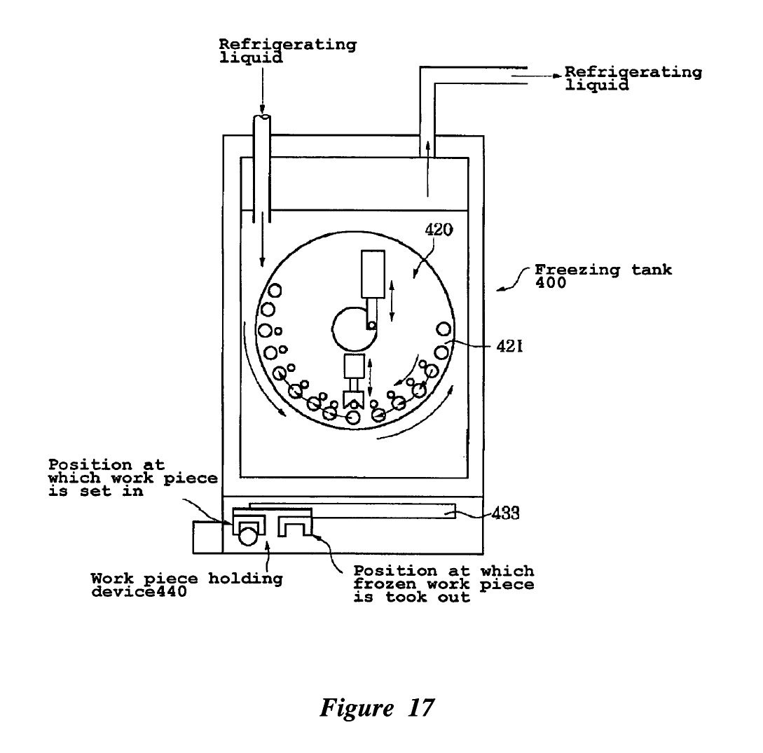

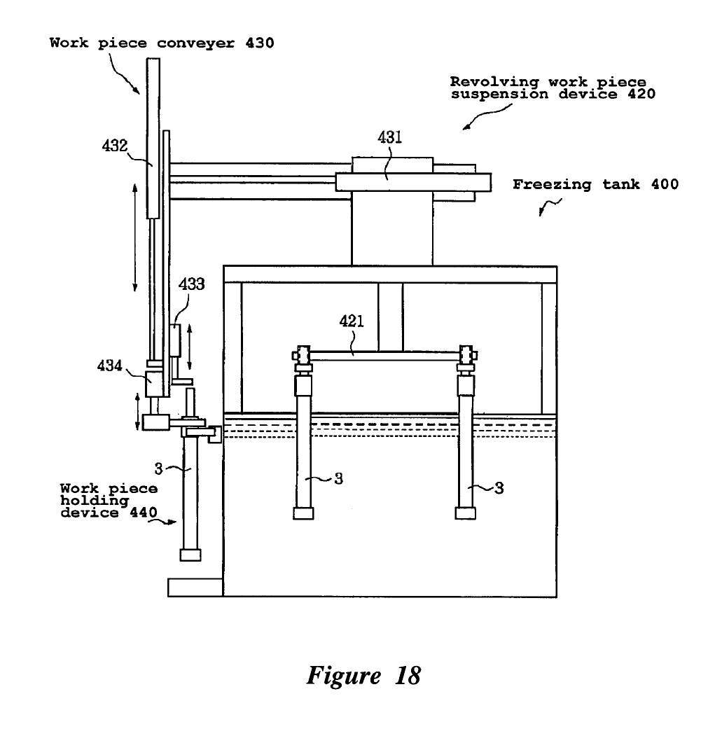

FIG. 16 through FIG. 18 show a freezing tank and a freezer. FIG. 16 is a schematic block diagram of the freezing tank and the freezer, FIG. 17 is a plan view of the freezing tank, and FIG. 18 is a side view of the freezing tank. The freezing tank 400 stores refrigerating liquid to a given liquid surface, level or volume, and the freezer 401 refrigerates the refrigerating liquid. A liquid-freezing circulation device 410 comprises a pump 402. The refrigerating liquid is circulated by the pump 402 between the freezing tank 400 and freezer 401. The refrigerating liquid comprises a nonfreezing liquid that preferably is maintained at an extremely low temperature, such as, for example but without limitation, about −20° C.

The freezing tank 400 preferably comprises a revolving work piece suspension device 420, a work piece conveyer 430 and a work piece holding device 440. The work piece holding device 440 temporarily stores material pipes.

The revolving work piece suspension device 420 comprises a pipe suspender 421. A plurality of material pipes preferably are suspended on the pipe suspender 421 over the freezing tank 400. While the material pipes are immersed in the refrigerating liquid in the freezing tank 400, the material pipes are revolved, which results in limited variation in freezing efficiency and freezing properties between pipes.

The work piece conveyer 430 comprises a transfer cylinder 431, an up-and-down cylinder 432, a left-and-right cylinder 433 and a clamp 434. Material pipes are conveyed from the work piece holding device 440 to the revolving work piece suspension device 420. Frozen material pipes are transferred from the revolving work piece suspension device 420 to the work piece holding device 440.

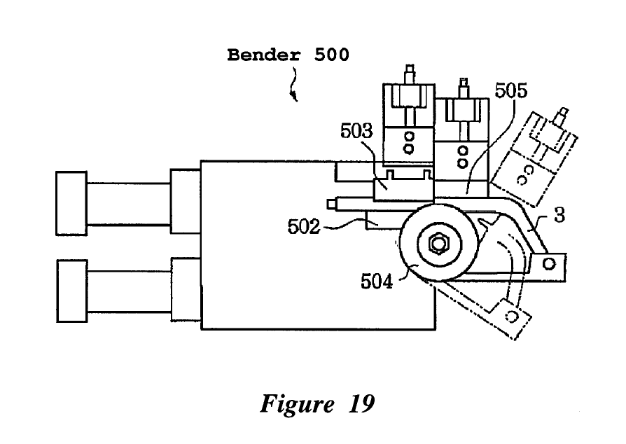

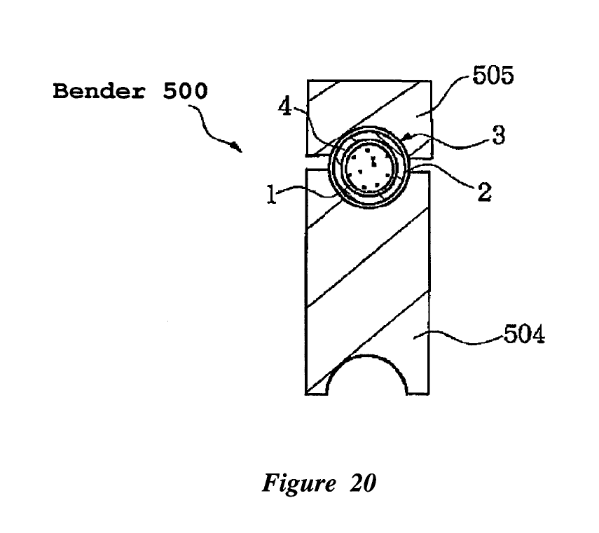

FIG. 19 and FIG. 20 show a bender. In particular, FIG. 19 is a plan view of the bender and FIG. 20 is a side view of a portion of the bender at which a material pipe is bent. The bender 500 preferably comprises a wiper die 502, a pressure die 503, a roll die 504 and a clamp die 505. The material pipe 3 is held between the wiper die 502 and the pressure die 503 The material pipe 3 also is held between the roll die 504 and the clamp die 505 The material pipe 3 is bent at the middle by the roll die 504 and the clamp die 505 rotating together.

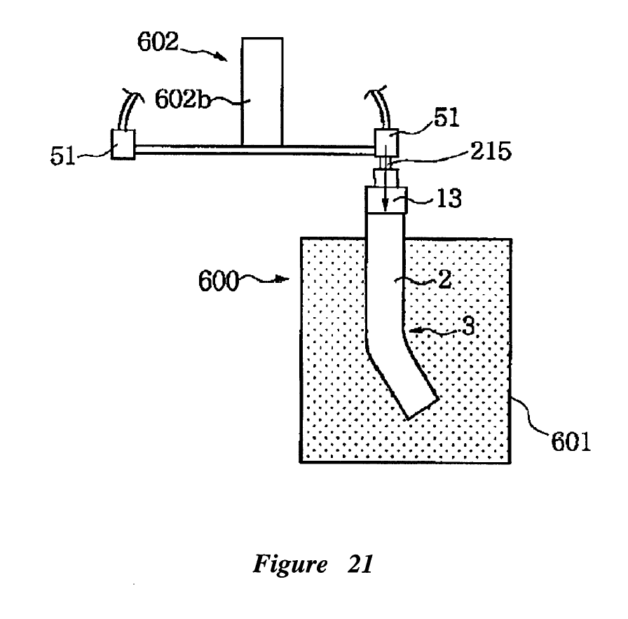

FIG. 21 shows a thawing machine. The illustrated thawing machine 600 comprises a revolving work piece hanger 602. A multiple pipe component 3 having the clamp-side plug 14 removed is suspended on the revolving work piece hanger 602. Preferably, the coupler-side plug 13 is up and the male-side coupler 215 is fitted in a female coupler of a hot-liquid feed plug 51. The multiple pipe component 3 can be immersed in heated ice-bending liquid and thawing can be performed by passing heated ice-bending liquid from the hot-liquid feed plug 51 through the interior of the multiple pipe component 3 via the check valve 215a, which is adapted to open on engagement of the female coupler and the passage 211a.

The illustrated revolving work piece hanger 602 comprises a plurality of hot-liquid feed plugs 51 disposed in the peripheral portion at given pitches. The plugs 51 are rotated intermittently with multiple pipe components 3 suspended on the plurality of hot-liquid feed plugs 51. The revolving work piece hanger 602 preferably is rotated by a motor (not shown) that is mounted on the center shaft 602b. The work piece hanger 602 also preferably can be moved up and down with a cylinder (not shown). When a multiple pipe component 3 is suspended on a hot-liquid feed plug 51 as the outside of the thawing tank 601, the revolving work piece hanger 602 is raised and then lowered after rotation of a given angle. Hot-liquid supplied from the hot-liquid feed plug 51 is started for the multiple pipe component 3 which is to be lowered inside the thawing tank 601. Multiple pipe components 3 are suspended in succession; raising, rotation and lowering are repeated; and hot-liquid introduction from the hot-liquid feed plug 51 continues until the hanger comes to a position at which the multiple pipe is displaced from inside the thawing tank 601 to the outside as a result of the next raising and rotation. In some configurations, the multiple pipe is removed after one or more advancement following the multiple pipe being removed from the thawing tank 601. The multiple pipe component 3 leaving the thawing tank 601 is removed and transferred to the plug opening machine 700. The removal and/or transportation can be manually performed or can be automated.

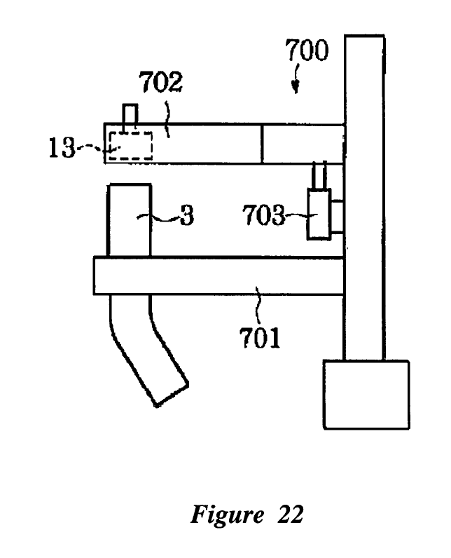

FIG. 22 shows a plug opening machine. The illustrated plug opening machine 700 comprises a clamp 701, a plug opener 702 and an up-and-down cylinder 703. The multiple pipe component 3 can be held by the clamp 701. The plug opener 702 can be moved by the up-and-down cylinder 703 to a position corresponding to the coupler-side plug 13. The nut of the coupler-side plug 13 then is loosened and removed by the plug opener 702.

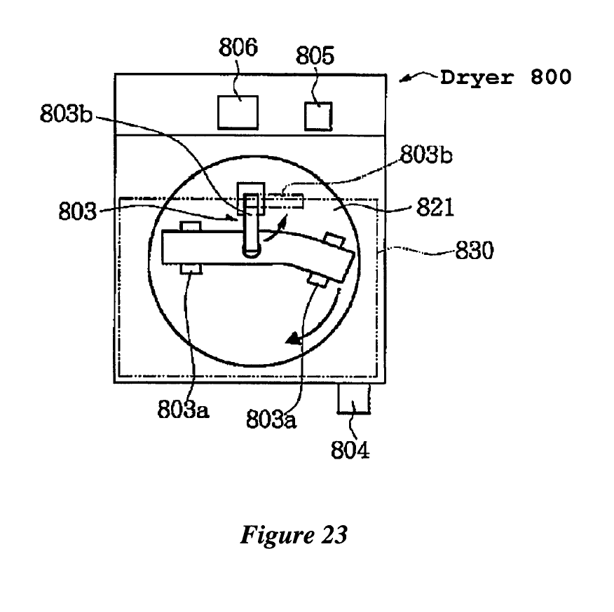

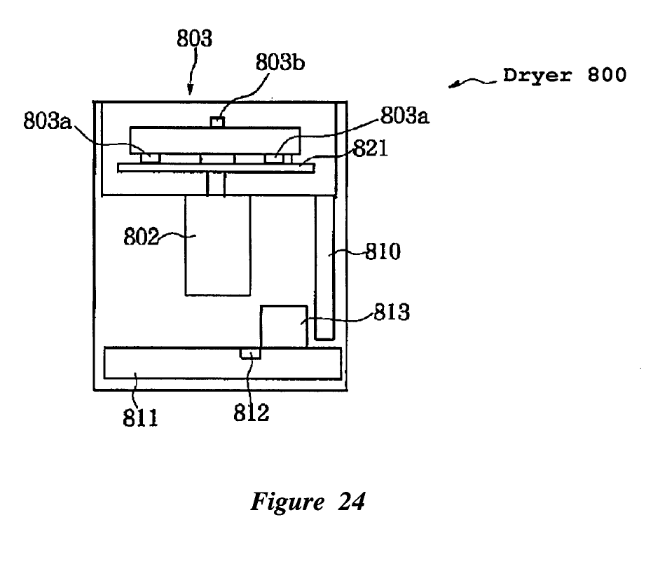

FIG. 23 and FIG. 24 show a dryer. In particular, FIG. 23 is a plan view of the dryer, and FIG. 24 is a side view of the dryer. The illustrated dryer 800 comprises a work piece rotating table 821 and a work piece rotating motor 802. The clamp device 803 preferably is provided on the work piece rotating table 821 and comprises a pair of support pieces 803a and a pusher 803b.

When a start button 804 is pressed, the pusher 803b is moved to a stopping position where it presses the multiple pipe component 3 and the work piece rotating table 821 is rotated by the work piece rotating motor 802 to begin drying by centrifugal force. When drying is completed (e.g., after the passing of a specified time), the pusher 803b automatically moves to a removal position and the multiple pipe component 3 can be removed. Preferably, the rotating time of the work piece rotating table 821 is set by a rotating-time setting timer 805 and the rotation speed is set by a rotation setting volume 806.

In the dryer 800, liquid extracted by centrifugal force is introduced into a discharge tank 811 through a drain pipe 810 and a specified amount of liquid is collected in the discharge tank 811, which is detected by a liquid level sensor 812 from the liquid level, and then a drain pump 813 is operated to discharge the liquid into the thawing tank 601.

In the illustrated dryer 800, an opening/closing door 830 is disposed upward of and in front of the work piece rotating table 821. When a start button 804 is pressed, the door is closed automatically and opened automatically after drying is completed. The work piece rotating table 821 preferably comprises a weight distribution such that a satisfactory rotation balance is obtained when the multiple pipe component 3 is clamped and undergoing a drying operation.

Further, the multiple pipe component 3 preferably is clamped such that it is located within the peripheral edge of the work piece rotating table 821 when viewed in plan. Moreover, the multiple pipe component 3 desirably is a pipe in which openings are provided, being open outward from between the inner pipe 1 and outer pipe 2, in the connecting portions of the inner pipe 1 and outer pipe 2 at both ends thereof, enabling an effective drying by centrifugal force.

Although the present invention has been described in terms of certain preferred embodiments, other embodiments apparent to those of ordinary skill in the art also are within the scope of this invention. Thus, various changes and modifications may be made without departing from the spirit and scope of the invention. For instance, various steps within the process may be combined, separated, reordered or replaced. In addition, other pieces of equipment can be used to perform the recited steps. Moreover, not all of the features, aspects and advantages are necessarily required to practice the present invention. Accordingly, the scope of the present invention is intended to be defined only by the claims that follow.

What is claimed is:

1. A multiple pipe component comprising at least one inner pipe and an outer pipe, a fibrous filler being disposed between the at least one inner pipe and the outer pipe at a portion of the multiple pipe component pipe that will be bent.

2. The multiple pipe component of claim 1, wherein the filler is formed with slits spaced at given pitches.

3. The multiple pipe component of claim 2, wherein holes are provided in the inner pipe on at least one of the downstream side and the upstream side of the portion of the multiple pipe component that will be bent and no holes are positioned in the portion of the multiple pipe component that will bent.

4. The multiple pipe component of claim 1, wherein holes are provided in the inner pipe on at least one of the downstream side and the upstream side of the portion of the multiple pipe component that will be bent and no holes are positioned in the portion of the multiple pipe component that will bent.

5. A method of manufacturing a multiple pipe component, the multiple pipe component comprising an inner pipe that is inserted into an outer pipe and a fibrous filler positioned around the outer circumference of the inner pipe, the method comprising introducing an ice-bending liquid into the multiple pipe, freezing the ice-bending liquid and, while the ice-bending liquid is frozen, bending the pipe in the region in which the filler is disposed.

6. The method of claim 5, wherein introducing the ice-bending liquid comprises a first introduction process in which the ice-bending liquid is introduced into the portion where the filler is positioned and a second introduction process in which the ice-bending liquid is introduced to a portion in which the filler is not positioned, and air in the portion where the filler is positioned is extracted.

7. The method of claim 6, wherein the second introduction process occurs after the first introduction process.

8. A method of manufacturing a multiple pipe component, the multiple pipe component comprising an outer pipe, at least one inner pipe disposed inside the outer pipe, and a fibrous filler positioned in at least one portion of a space defined between the at least one inner pipe and the outer pipe, the multiple pipe component comprising a region that will be bent, the method comprising supplying a liquid into the inner pipe at the region that will be bent and supplying a liquid to the space between the pipes including the portion where the filler is disposed, the liquid being frozen after being supplied, and the pipe being bent after the liquid is frozen, and when the liquid is fed into the portion where the filler is disposed, the supply of the liquid occurs by one or more of the following two process: a process in which the liquid is supplied under pressure from at least one side of the portion where the filler is positioned and a process in which the liquid is supplied from one side of the portion where the filler is disposed while it is depressurized from the other side thereof.

9. The method of claim 8, wherein the liquid is separately supplied to the region containing the filler and to the region not containing the filler during two individual operations.

10. A method of manufacturing a multiple pipe made up of at least one inner pipe and one outer pipe, a pipe bending portion being defined between the ends of the multiple pipe, outer space defined between the outer pipe and the inner pipe, an inner space defined within the inner pipe, a fibrous filler being disposed at the pipe bending portion of the multiple pipe in the outer space, an opening between the outer space and the inner space in a region outside of the pipe bending portion, holes being provided in the inner pipe on at least one of the downstream side and the upstream side of the pipe bending portion and no holes being disposed at the bending portion, the method comprising inclining the multiple pipe into a generally vertical orientation with the holes being positioned vertically lower than the pipe bending portion and the opening being positioned vertically higher than the filler, blocking the inner pipe with a seal at a position vertically above the holes and vertically below the opening, supplying a liquid under pressure from a location generally below the seal, removing the seal is after the liquid is fed from the holes through the portion where the filler is disposed and through the opening, introducing a specified amount of liquid into the inner pipe of the multiple pipe, freezing the liquid in the multiple pipe and bending the multiple pipe in the pipe bending portion while the liquid is frozen.

11. A method of manufacturing a multiple pipe component that comprises at least one inner pipe and an outer pipe, the multiple pipe component comprising a bending region that will be bent, the at least one inner pipe having an upstream portion positioned to one side of the bending region and a downstream portion positioned to the other side of the bending region, the method comprising positioning a fibrous filler between the outer pipe and the at least one inner pipe at the bending region with an opening between the at least one inner pipe and the outer pipe being located at a position vertically higher than the filler, creating holes through the inner pipe on at least one of the downstream portion and the upstream portion and not creating holes through the inner pipe in the bending region, positioning the multiple pipe component in either a vertically inclined position or a substantially upright position with the holes through the inner pipe being positioned vertically lower than the pipe bending portion, substantially sealing the inner pipe with a seal positioned at a position generally vertically higher than the holes, feeding a liquid under pressure from a lower end of the outer pipe, and removing the seal from the inner pipe after the liquid is introduced

12. A method of manufacturing a multiple pipe comprising an outer pipe and at least one inner pipe disposed inside the outer pipe, an outer space being defined between the outer pipe and the at least one inner pipe, an inner space being defined within the inner pipe, a fibrous filler disposed in the outer space in a bending region of the multiple pipe, the method comprising plugging the multiple pipe at the lower end, positioning the multiple pipe generally upright, supplying a liquid into the inner space at the bending portion and the outer space, including the bending portion that contains the filler, vibrating the multiple pipe to extract air bubbles, freezing the liquid and bending the multiple pipe.

13. A device for manufacturing a multiple pipe, the multiple pipe comprising an inner pipe extending into an outer pipe, a fibrous filler being positioned around an outside circumference of the inner pipe, the device comprising a pressurized liquid introduction machine capable of supplying an ice-bending liquid into the portion where the filler is disposed, a plugging and liquid introduction machine for plugging both ends of the multiple pipe and supplying a specified amount of ice-bending liquid into the pipe, a freezing machine for freezing the ice-bending liquid inserted into the multiple pipe, a bending machine for bending the frozen multiple pipe at the portion where the filler is disposed and a thawing machine for thawing the frozen ice-bending liquid in the multiple pipe.

14. A device for manufacturing a multiple pipe, the multiple pipe comprising an outer pipe and at least one inner pipe extending inside the outer pipe, a fibrous filler being disposed in a space between the outer pipe and the at least one inner pipe, the device comprising a bending machine for bending the multiple pipe at the portion where the filler is dispose in the longitudinal direction, a liquid supply device for supplying a liquid into the at least one inner pipe at the bending portion and a space between the at least one inner pipe and the outer pipe, including the portion where the filler is disposed, a freezing device for freezing the liquid after introduction, a bending machine for bending the multiple pipe after freezing, and a thawing device for thawing the frozen liquid in the multiple pipe after bending, wherein the liquid supply device supplies the liquid under pressure from at least one side of the portion where the filler is disposed or the liquid supply device supplies the liquid from one side of the portion where the filler is disposed while a vacuum is applied to the other side.

15. The device of claim 14, wherein the lower end of the multiple pipe is plugged tightly before the freezing, the multiple pipe is inclined to the vertical direction or raised upright, and there is provided a bubble extracting machine for extracting bubbles in the portion where the filler is disposed by applying a vibration to the multiple pipe.

16. The device of claim 14, wherein the liquid supplying device comprises a first liquid supplying machine for introducing the liquid into the portion where the filler is disposed and a second liquid supplying machine for introducing the liquid into the portion where the filler is not disposed.

17. The device of claim 16, wherein the lower end of the multiple pipe is plugged tightly before the freezing, the multiple pipe is inclined to the vertical direction or raised upright, and there is provided a bubble extracting machine for extracting bubbles in the portion where the filler is disposed by applying a vibration to the multiple pipe.

18. A device for manufacturing a multiple pipe, the multiple pipe comprising an outer pipe and an inner pipe positioned at least partially inside of said outer pipe, a fibrous filler being disposed between the outer pipe and the inner pipe in a bending portion, holes being provided in the inner pipe on at least one of a downstream side and an upstream side of the bending portion while the holes are not disposed in the bending portion, the multiple pipe being filled with liquid in a generally vertical orientation with the holes disposed further downward than the bending portion and an opening between the outer pipe and the inner pipe being located at a position further upward than the portion where the filler is disposed, and the inner pipe being blocked with a seal at a position further upward than the holes, the device comprising: a first supply machine for introducing a liquid under pressure from the lower end of the outer pipe, the first supply machine being capable of introducing the liquid from the opening into the portion where the filler is disposed; a second supply machine for supplying a specified amount of ice-bending liquid into the inner pipe of the multiple pipe; a bending machine for bending the multiple pipe at the portion where the filler is disposed with the liquid inside the multiple pipe frozen; and a thawing device for thawing the frozen liquid inside the multiple pipe.

19. The device of claim 18, wherein the lower end of the multiple pipe is plugged tightly before the freezing, the multiple pipe is inclined to the vertical direction or raised upright, and there is provided a bubble extracting machine for extracting bubbles in the portion where the filler is disposed by applying a vibration to the multiple pipe.

20. A device for manufacturing a multiple pipe made up of an outer pipe and at least one inner pipe disposed inside the outer pipe, and having a fibrous filler disposed at least in one place of the inner pipe or the space between pipes, the device comprising a bending machine for bending the multiple pipe at the place where the filler is disposed in the longitudinal direction, a liquid supply device for introducing, prior to bending, a liquid into the inner pipe inside the outer pipe at the bending portion and the space between pipes including the portion where the filler is disposed, a bubble extracting machine for extracting bubbles in the portion where the filler is disposed by applying a vibration to the multiple pipe having a lower end plugged tightly and inclined to the vertical direction or raised upright and a freezing device for freezing the liquid supplied to the multiple pipe after the extraction of the bubbles, wherein the bending machine bends the multiple pipe after the liquid fed into the multiple pipe is frozen.
